(19) United States
(12) Patent Application Publication
(10) Pub. No.: US 2009/0117980 A1
(43) Pub. Date: May 7, 2009

(54) Game System Including Slot Machines And Game Control Method Thereof

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/188,823

(22) Filed: Aug. 8, 2008

Related U.S. Application Data
(60) Provisional application No. 60/985,433, filed on Nov. 5, 2007.

(51) Int. Cl. A63F 9/24; A63F 13/00

(52) U.S. Cl. 463/20

(57) ABSTRACT

A gaming system is provided with a plurality of slot machines 13, a central controller 11, and a large-size monitor 14. Each of the plurality of slot machines transmits symbol data related to a stationary symbol of a reel to the central controller 11. The central controller 11 determines whether a combination formed by a plurality of symbols represented by a plurality of symbol data corresponds to a specified combination for providing an award. In a case where the combination formed by a plurality of symbols represented by a plurality of symbol data corresponds to a specified combination for providing an award, the central controller 11 transmits a winning data for providing an award to the slot machines 13.

### CROSS REFERENCE TO RELATED APPLICATIONS

This application claims the benefit of U.S. Provisional App. No. 60/985,433, filed Nov. 5, 2007, the entire contents of which are incorporated herein by reference.

### BACKGROUND OF THE INVENTION

1. Field of the Invention

The present invention relates to a gaming system which is capable of executing a collaborate game which produces one result based on a plurality of results acquired from each of a plurality of slot machines and a control method thereof.

2. Related Art

Conventionally, a gaming system has been known which is connected to a network and accumulates a portion of gaming credits inserted in a plurality of slot machines, so that a portion of gaming credits is paid out in the form of a jackpot to a specified slot machine when a predetermined condition is achieved. The jackpot is, for example, achieved when randomly determined by a controller, when a so-called bonus game is cleared by a player, and so on. For example, U.S. Pat. No. 7,056,215 discloses a gaming machine that selects a number within a predetermined range of numbers such as a bet number and during each game so as to provide allowance to randomly perform a jackpot game to a specified slot machine.

Thus, the conventional gaming system allows a plurality of players to compete for a jackpot to acquire accumulated gaming credits among a plurality of slot machines. That is, a plurality of slot machines competes with each other for one jackpot.

The present invention provides a slot machine with new entertainment characteristics and a game control method.

### SUMMARY OF THE INVENTION

In a first aspect of the present invention, a gaming system includes a plurality of slot machines transmitting symbol data of a stationary symbol; and a central controller for establishing communication with each of the plurality of slot machines, in which the central controller is configured to perform the following operations of: (a) receiving a plurality of the symbol data transmitted from each of the plurality of slot machines; (b) determining whether a combination which is formed by the plurality of symbol data thus received corresponds to a specified combination; and (c) in a case where a combination which is formed by the plurality of symbol data corresponds to a specified combination, transmitting winning data for providing an award to each of the plurality of slot machines.

According to a gaming system of the first aspect of the present invention, the central controller is configured to perform the following operations of: (a) receiving a plurality of the symbol data transmitted from each of the plurality of slot machines; (b) determining whether a combination which is formed by the plurality of symbol data thus received corresponds to a specified combination; and (c) in a case where a combination which is formed by the plurality of symbol data corresponds to a specified combination, transmitting winning data for providing an award to each of the plurality of slot machines.

In a second aspect of the present invention, a gaming system according to the first aspect further includes a display device for displaying an image for establishing communication with the central controller, the display device being disposed at a location able to be visually recognized by a player operating each of the plurality of slot machines, and the central controller is configured to further perform the following operation of displaying each of symbols corresponding to the symbol data on the display device in response to a reception of symbol data of the stationary symbol from each of the plurality of slot machines.

In a gaming system of the second aspect according to the first aspect of the present invention, the gaming system includes a display device for displaying an image for establishing communication with the central controller, the display device being disposed at a location able to be visually recognized by a player operating each of the plurality of slot machines, and the central controller is configured to further perform the following operation of displaying each of symbols corresponding to the symbol data on the display device in response to a reception of symbol data of the stationary symbol from each of the plurality of slot machines.

In a third aspect of the present invention according to the gaming system of the first aspect, each of the plurality of slot machines transmits to the central controller data of an amount of credits inserted in the form of coins, and the central controller includes memory for storing accumulation coin data, and is configured to further perform the following operations of: (a) storing in the memory a predetermined ratio in the data of an amount of credits inserted in the forms of coins received from the plurality of slot machines as the accumulation coin data; and (b) in a case where a combination which is formed by the plurality of symbol data corresponds to a specified combination, transmitting the accumulation coin data as winning data.

According to a gaming system of the third aspect of the present invention according to the gaming system of the first aspect, each of the plurality of slot machines transmits to the central controller data of an amount of credits inserted in the form of coins. Then, the central controller is configured to further perform the following operations of storing in the memory a predetermined ratio in the data of an amount of credits inserted in the form of coins received from the plurality of slot machines as the accumulation coin data and, in a case where a combination which is formed by the plurality of symbol data corresponds to a specified combination, transmitting the accumulation coin data as winning data.

In a fourth aspect of the present invention according to the gaming system of the first aspect, each of the plurality of slot machines includes a display unit for displaying at least two stationary symbols and a local controller configured to perform the following operations of transmitting to the central controller symbol data related to a first stationary symbol of the at least two stationary symbols, in a case where a second stationary symbol of the at least two stationary symbols is a specified symbol for providing an award, providing an award corresponding to the specified symbol, and in a case of receiving the winning data, providing an award corresponding to the winning data.

According to a plurality of slot machines in a gaming system of the fourth aspect of the present invention according to the plurality of slot machines in the gaming system of the first aspect, each of the plurality of slot machines includes a display unit for displaying at least two stationary symbols and a local controller configured to perform the following operations of transmitting to the central controller symbol data related to a first stationary symbol of the at least two stationary symbols, in a case where a second stationary symbol of the at least two stationary symbols is a specified symbol for providing an award, providing an award corresponding to the specified symbol, and in a case of receiving the winning data, providing an award corresponding to the winning data.

In a fifth aspect of the present invention according to the first aspect, each of the plurality of slot machines includes a display unit for displaying at least two stationary symbols and a local controller for transmitting first symbol data, which is data for a first stationary symbol, and second symbol data, which is data for a second stationary symbol, of the at least two stationary symbols, and the central controller is configured to further perform the following operations of (a) receiving the first symbol data and the second symbol data respectively from each of the plurality of slot machines (b) determining whether a combination formed by a plurality of the first symbol data and a combination formed by a plurality of the second symbol data corresponds to a specified combination, respectively, and (c) in a case where at least any one of a combination formed by a plurality of the first symbol data or a combination formed by a plurality of the second symbol data corresponds to the specified combination, transmitting the winning data to each of the plurality of slot machines.

According to a gaming system of the fifth aspect of the present invention as described in the gaming system of the first aspect, each of the plurality of slot machines includes a display unit for displaying at least two stationary symbols and a local controller for transmitting first symbol data, which is data for a first stationary symbol, and second symbol data, which is data for a second stationary symbol, of the at least two stationary symbols, and the central controller is configured to further perform the following operations of (a) receiving the first symbol data and the second symbol data respectively from each of the plurality of slot machines (b) determining whether a combination formed by a plurality of the first symbol data and a combination formed by a plurality of the second symbol data corresponds to a specified combination, respectively and (c) in a case where at least any one of a combination formed by a plurality of the first symbol data or a combination formed by a plurality of the second symbol data corresponds to the specified combination, transmitting the winning data to each of the plurality of slot machines.

In a sixth aspect of the present invention according to the first aspect, the central controller is configured to further perform the following operation of transmitting combination data, which is data of a combination formed by symbol data received from each of the plurality of slot machines, to each of the plurality of slot machines, and each of the plurality of slot machines includes a display unit for displaying to a player at least two stationary symbols and a symbol corresponding to combination data transmitted from the central controller and a controller configured to perform the following operations of (A) transmitting symbol data, which is data for a first stationary symbol of the at least two stationary symbols, (B) displaying the combination data received from the central controller on the display unit, (C) in a case where a second stationary symbol of the at least two stationary symbols is a specified symbol for providing an award, providing an award corresponding to the specified symbol, and (D) in a case of receiving the winning data, providing an award corresponding to the winning data.

In a gaming system of the sixth aspect of the present invention according to the gaming system of the first aspect, the central controller is configured to further perform the following operation of transmitting combination data, which is data of a combination formed by symbol data received from each of the plurality of slot machines, to each of the plurality of slot machines. Then, each of the plurality of slot machines is configured to perform the following operations of transmitting symbol data, which is data for a first stationary symbol of the at least two stationary symbols displaying the combination data received from the central controller on the display unit, in a case where a second stationary symbol of the at least two stationary symbols is a specified symbol for providing an award, providing an award corresponding to the specified symbol, and in a case of receiving the winning data, providing an award corresponding to the winning data.

In a seventh aspect of the present invention, a gaming system includes a plurality of slot machines having a display unit for displaying at least two stationary symbols and a local controller for performing processing related to a game, a display device for displaying an image, the display device being disposed at a location able to be visually recognized by a player operating each of the plurality of slot machines and a central controller for establishing communication with each of the plurality of slot machines, and the local controller is configured to perform the following operations of (A) transmitting symbol data related to a first stationary symbol of the at least two stationary symbols, and (B) in a case where symbol data related to a second stationary symbol of the at least two stationary symbols is a specified symbol for providing an award, providing an award corresponding to the specified symbols, and the central controller is configured to perform the following operations of (a) receiving each of the symbol data from the plurality of slot machines, (b) displaying each of the symbols corresponding to the symbol data on the display device in response to a reception of a plurality of symbol data of the stationary symbols from each of the plurality of slot machines, (c) determining whether a combination formed by the plurality of symbol data thus received corresponds to a specified combination, and (d) in a case where a combination formed by the plurality of symbol data corresponds to the specified combination, transmitting winning data for providing an award to each of the plurality of slot machines.

In the gaming system of the seventh aspect of the present invention, the gaming system is provided with a plurality of slot machines, display devices, and a central controller. The plurality of slot machines having a display unit for displaying at least two stationary symbols are configured to control the following operations of transmitting symbol data related to a first stationary symbol and, in a case where symbol data related to a second stationary symbol is a specified symbol for providing an award, providing an award corresponding to the specified symbols. Furthermore, the central controller is configured to perform the following operations of (a) receiving each of the symbol data from the plurality of slot machines, (b) displaying each of the symbols corresponding to the symbol data on the display device in response to a reception of a plurality of symbol data of the stationary symbols from each of the plurality of slot machines, (c) determining whether a combination formed by the plurality of symbol data thus received corresponds to a specified combination, and (d) in a case where a combination formed by the plurality of symbol data corresponds to the specified combination, transmitting winning data for providing an award to each of the plurality of slot machines.

In an eighth aspect of the present invention according to the seventh aspect, each of the plurality of slot machines transmits data of an amount of credits inserted in the form of coins to the central controller, and the central controller includes memory for storing accumulation coin data and is configured to further perform the following operations of (a) storing in the memory a predetermined ratio in the data of an amount of credits inserted in the form of coins received from the plurality of slot machines as the accumulation coin data, and (b) in a case where a combination, which is formed by the plurality of symbol data, corresponds to the specified combination, transmitting the accumulation coin data as the winning data.

In a gaming system of the eighth aspect of the present invention according to the gaming system of the seventh aspect, the central controller includes memory for storing accumulation coin data and is configured to further perform the following operations of (a) storing in the memory a predetermined ratio in the data of an amount of credits inserted in the form of coins received from the plurality of slot machines as the accumulation coin data, and (b) in a case where a combination, which is formed by the plurality of symbol data, corresponds to the specified combination, transmitting the accumulation coin data as the winning data.

In a ninth aspect of the present invention, a gaming system includes a plurality of slot machines having a display unit for displaying at least two stationary symbols and a local controller for performing processing related to a game, a display device for displaying an image, the display device being disposed at a location able to be visually recognized by a player operating each of the plurality of slot machines, and a central controller for establishing communication with each of the plurality of slot machines, and the local controller is configured to perform the following operations of (A) transmitting first symbol data, which is data for a first stationary symbol, and second symbol data, which is data for a second stationary symbol, of the at least two stationary symbols, and (B) in a case where at least any one of the first stationary symbol and the second stationary symbol corresponds to a specified symbol for providing an award, providing an award, in which the central controller is configured to perform the following operations of (a) receiving the first symbol data and the second symbol data, respectively, from each of the plurality of slot machines, (b) displaying each of symbols corresponding to the first symbol data and the second symbol data on the display device in response to the reception of symbol data of the stationary symbols from each of the plurality of slot machines, (c) determining whether a combination formed by a plurality of the first symbol data and a combination formed by a plurality of the second symbol data respectively corresponds to a specified combination, and (d) in a case where any one of a combination formed by a plurality of the symbol data and a combination formed by a plurality of the symbol data corresponds to the specified combination, transmitting winning data for providing an award to each of the plurality of slot machines.

In the gaming system of the ninth aspect of the present invention, the gaming system is provided with a plurality of slot machines, a display device, and a central controller, and the plurality of slot machines having a display unit for displaying at least two stationary symbols are configured to perform the following operations of (A) transmitting first symbol data, which is data for a first stationary symbol, and second symbol data, which is data for a second stationary symbol, and (B) in a case where at least any one of the first stationary symbol and the second stationary symbol corresponds to a specified symbol for providing an award, providing an award. Furthermore, the central controller is configured to perform the following operations of (a) receiving the first symbol data and the second symbol data, respectively, from each of the plurality of slot machines, (b) displaying each of symbols corresponding to the first symbol data and the second symbol data on the display device in response to the reception of symbol data of the stationary symbols from each of the plurality of slot machines, (c) determining whether a combination formed by a plurality of the first symbol data and a combination formed by a plurality of the second symbol data, respectively, corresponds to a specified combination, and (d) in a case where any one of a combination formed by a plurality of the first symbol data and a combination formed by a plurality of the second symbol data corresponds to the specified combination, transmitting winning data for providing an award to each of the plurality of slot machines.

In a tenth aspect of the present invention, a gaming system includes a plurality of slot machines having a display unit for displaying at least two stationary symbols and a local controller for performing processing related to a game and a central controller for establishing communication with each of the plurality of slot machines, in which the central controller is configured to perform the following operations of (a) receiving a plurality of symbol data transmitted from each of the plurality of slot machines, (b) transmitting combination data, which is data for a combination formed by symbol data received from each of the plurality of slot machines, to each of the plurality of slot machines, (c) determining whether a combination formed by the plurality of symbol data thus received corresponds to a specified combination, and (d) in a case where a combination formed by the plurality of symbol data corresponds to the specified combination, transmitting winning data for providing an award to each of the plurality of slot machines, in which the local controller is configured to perform the following operations of (A) transmitting symbol data, which is data for a first stationary symbol of the at least two stationary symbols, to the central controller, (B) displaying the combination data received from the central controller on the display unit, (C) in a case where a second stationary symbol of the at least two stationary symbols corresponds to a specified symbol, providing an award corresponding to the specified symbol, and (D) in a case of receiving the winning data, providing an award corresponding to the winning data.

In a gaming system according to the tenth aspect of the present invention, the gaming system is provided with a plurality of slot machines and a central controller, in which the central controller is configured to perform the following operations of (a) receiving a plurality of symbol data transmitted from each of the plurality of slot machines, (b) determining whether a combination formed by the plurality of symbol data thus received corresponds to a specified combination, and (c) in a case where a combination formed by the plurality of symbol data corresponds to the specified combination, transmitting winning data for providing an award to each of the plurality of slot machines. Furthermore, a plurality of slot machines are configure to perform the following operations of (A) transmitting symbol data, which is data for a first stationary symbol of the at least two stationary symbols, to the central controller and displaying the combination data received from the central controller on the display unit, and (B) in a case where a second stationary symbol of the at least two stationary symbols corresponds to a specified symbol, providing an award corresponding to the specified symbol, and in a case of receiving the winning data, providing an award corresponding to the winning data.

In an eleventh aspect of the present invention, a method of controlling a game of a gaming system having a plurality of slot machines and a central controller for establishing communication with each of the plurality of slot machines, includes (a) the plurality of slot machines transmitting symbol data of a stationary symbol, (b) the central controller receiving a plurality of the symbol data transmitted from each of the plurality of slot machines, (c) the central controller determining whether a combination formed by a plurality of the slot machines thus received corresponds to a specified combination; and (d) in a case where a combination formed by a plurality of the symbol data corresponds to the specified combination, the central controller transmitting winning data for providing an award to each of the plurality of slot machines.

A method of controlling a game in the eleventh aspect of the present invention includes (a) the plurality of slot machines transmitting symbol data of a stationary symbol, (b) the central controller receiving a plurality of the symbol data transmitted from each of the plurality of slot machines, (c) the central controller determining whether a combination formed by a plurality of the slot machines thus received corresponds to a specified combination; and (d) in a case where a combination formed by a plurality of the symbol data corresponds to the specified combination, the central controller transmitting winning data for providing an award to each of the plurality of slot machines.

In a twelfth aspect of the present invention according to the tenth aspect, the gaming system includes a display device for displaying an image so as to establish communication with the central controller, the display device being disposed at a location able to be visually recognized by a player operating each of the plurality of slot machines, and the gaming system further includes a step in which the central controller displays each of the symbols corresponding to the symbol data on the display device in response to reception of symbol data of the stationary symbol from each of the plurality of slot machines.

A method of controlling a game in the twelfth aspect of the present invention according to the method of controlling a game in the tenth aspect includes a display device for displaying an image so as to establish communication with the central controller, the display device being disposed at a location able to be visually recognized by a player operating each of the plurality of slot machines, and the gaming system further includes a step in which the central controller displays each of the symbols corresponding to the symbol data on the display device in response to reception of symbol data of the stationary symbol from each of the plurality of slot machines.

In a thirteenth aspect of the present invention according to the eleventh aspect, the gaming system performs a step in which each of the plurality of slot machines transmits data of an amount of credits inserted in the form of coins to the central controller, in which the central controller includes memory for storing accumulation coin data and is configured to further perform the following operations of storing in the memory a predetermined ratio in the data of an amount of credits inserted in the form of coins received from the plurality of slot machines as the accumulation coin data, and in which, in a case where a combination which is formed by the plurality of symbol data corresponds to a specified combination, the accumulation coin data is transmitted as the winning data.

In the method of controlling a game of the thirteenth aspect of the present invention according to the eleventh aspect, the gaming system includes the step in which each of the plurality of slot machines transmits data of an amount of credits inserted in the form of coins to the central controller, and also includes the central controller which is configured to further perform the following operations of storing in the memory a predetermined ratio in the data of an amount of credits inserted in the form of coins received from the plurality of slot machines as the accumulation coin data, and in a case where a combination which is formed by the plurality of symbol data corresponds to a specified combination, the accumulation coin data is transmitted as the winning data.

### BRIEF DESCRIPTION OF THE DRAWINGS

FIG. 1 is a flowchart showing the flow of a game executed in a gaming system according to an embodiment of the present invention;

FIG. 2 is a diagram showing a schematic configuration of the gaming system according to an embodiment of the present invention;

FIG. 3 is a perspective diagram showing an external configuration of the gaming system according to an embodiment of the present invention;

FIG. 4 is a block diagram of a central controller of the gaming system according to an embodiment of the present invention;

FIG. 5 is a perspective diagram showing an external configuration of the gaming system according to an embodiment of the present invention;

FIG. 6 is an enlarged front view showing an enlarged view of the display region of the slot machine configuring the gaming system according to an embodiment of the present invention;

FIG. 7 is a block diagram showing a slot machine configuring a gaming system according to an embodiment of the present invention;

FIG. 8 is a block diagram showing a display/input controller of the slot machine according to an embodiment of the present invention;

FIG. 9 is a diagram showing symbol lines displayed on the respective video reels of the slot machine according to an embodiment of the present invention;

FIG. 10 is a diagram showing a symbol arrangement table according an embodiment of the present invention;

FIGS. 11A and 11B are the flowcharts of game processing executed in the slot machine configuring a gaming system according to an embodiment of the present invention;

FIG. 12 is a flowchart of game processing executed in the central controller configuring a gaming system according to an embodiment of the present invention;

FIG. 13 is a diagram showing a random number table for a basic game according to an embodiment of the present invention;

FIG. 14 is a diagram showing a combination table according to an embodiment of the present invention;

FIGS. 15A and 15B are diagrams showing display examples of a game executed in the gaming system according to an embodiment of the present invention;

FIGS. 16A and 16B are diagrams showing display examples of a game executed in the gaming system according to a variation example of the present invention;

FIG. 17 is a diagram showing a display example of a game executed in the gaming system according to a variation example of the present invention; and

FIG. 18 is a flowchart of processing executed in the central controller configuring the gaming system according to a variation example of the present invention.

### DETAILED DESCRIPTION OF THE INVENTION

An embodiment of the present invention is described below with reference to the accompanying drawings.

A gaming system 10 according to the present invention includes a plurality of slot machines 13, a central controller 11 controlling the gaming system 10, for establishing communication with each of the plurality of slot machines, and a large-size monitor 14 controlled by the central controller 11. The plurality of slot machines 13 includes liquid crystal displays 30 and 40 as display units, each of which displays video reels 3A and 4A, respectively. CPU 106 of the slot machine 13 transmits symbol data of stationary symbols on the video reel 3A to the central controller 11, and pays out coins in a case where a stationary symbol on the video reel 3B corresponds to a specified symbol for providing an award. When CPU 206 of the central controller 11 receives respective symbol data from the plurality of slot machines 13, the CPU 206 displays the corresponding symbols on the large-size monitor 14. Furthermore, the CPU 206 determines whether a combination formed by symbols corresponding to a plurality of symbol data corresponds to a specified combination for providing an award. Then, in a case where a combination formed by symbols corresponds to a specified combination for providing an award, the CPU 206 transmits winning data for providing an award to each slot machine 13.

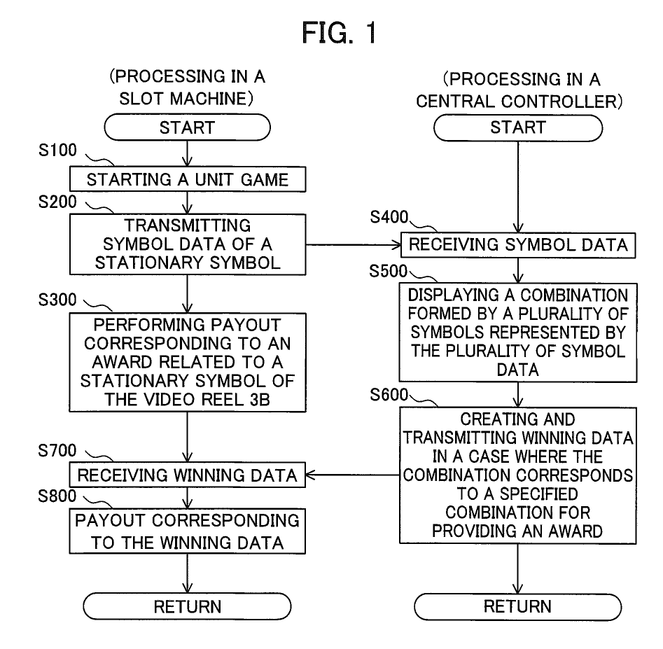

More specifically, although details are described later, as shown in FIG. 1, the CPU 106 of the slot machine 13 starts a unit game in response to reception of a signal from a start switch 25 (Step S100). When rotation of each video reel 3A and 3B is stopped, the CPU 106 transmits symbol data of a stationary symbol related to the video reel 3A to the central controller 11 (Step S200) and performs payout corresponding to an award related to a stationary symbol of the video reel 3B (Step S300). On the other hand, the CPU 206 of the central controller 11 receives symbol data from a plurality of slot machines 13 (Step S400) and displays a combination formed by a plurality of symbols represented by the plurality of symbol data on the large-size monitor 14 (Step S500). Then, the CPU 206 transmits winning data in a case where the combination corresponds to a specified combination for providing an award (Step S600). The CPU 106 of the slot machine 13 which received the winning data (Step S700) performs payout corresponding to the winning data (Step S800).

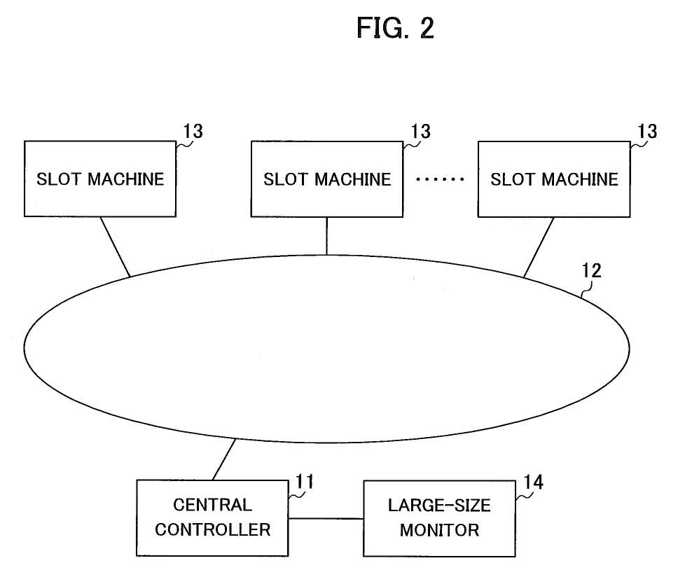

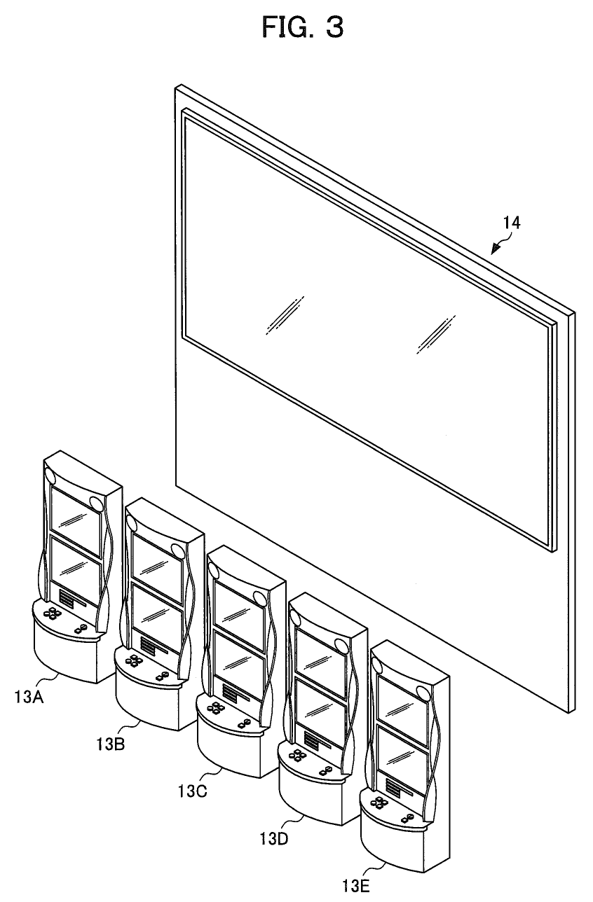

A description is provided regarding a gaming system 10 according to an embodiment of the present embodiment. FIG. 2 is a diagram showing a schematic configuration of the gaming system 10 according to the embodiment of the present invention. FIG. 3 is a perspective diagram showing an example of the installed gaming system 10. As shown in FIGS. 2 and 3, the gaming system 10 includes mainly a central controller 11 and a plurality of slot machines 13. The central controller 11 and the plurality of slot machines 13 are connected with each other for establishing communication, thereby forming a network 12. Furthermore, a large-size monitor 14 is disposed at a location able to be visually recognized by a player operating each of the plurality of slot machines 13.

The central controller 11 controls the entire gaming system 10. More specifically, the central controller 11 controls the plurality of slot machines 13 via the network 12.

As shown in FIG. 3, the plurality of slot machines 13 is a terminal for a player playing a game in the gaming system 10. In the present embodiment, five slot machines 13A, 13B, 13C, 13D, and 13E are connected with the central controller 11 for establishing communication, thereby forming the network 12. Each of these slot machines transmits symbol data related to stationary symbols to the central controller 11. Each of these slot machines 13 is provided with two video reels 3A and 3B. In the present embodiment, each of these slot machines 13 transmits to the central controller 11 symbol data related to the stationary symbol which is a first stationary symbol displayed on the video reel 3A. In other words, each of these slot machines 13 transmits to the central controller 11 symbol data related to each stationary symbol in each slot machine 13.

The large-size monitor 14 is controlled by the central controller 11 and displays a symbol image corresponding to symbol data transmitted from each of the plurality of slot machines 13. More specifically, the central controller 11 which received the symbol data transmits signals to the large-size monitor 14 so as to display a symbol image corresponding to respective symbol data, and then, the large-size monitor 14 which received the signals displays a plurality of symbol images. Thus, a stationary symbol in each of the plurality of slot machines 13 is displayed on the large-size monitor 14. As described later, one combination is formed by all the plurality of stationary symbols thus displayed on the large-size monitor 14.

A description is provided regarding each configuration of the gaming system 10 according to the present embodiment.

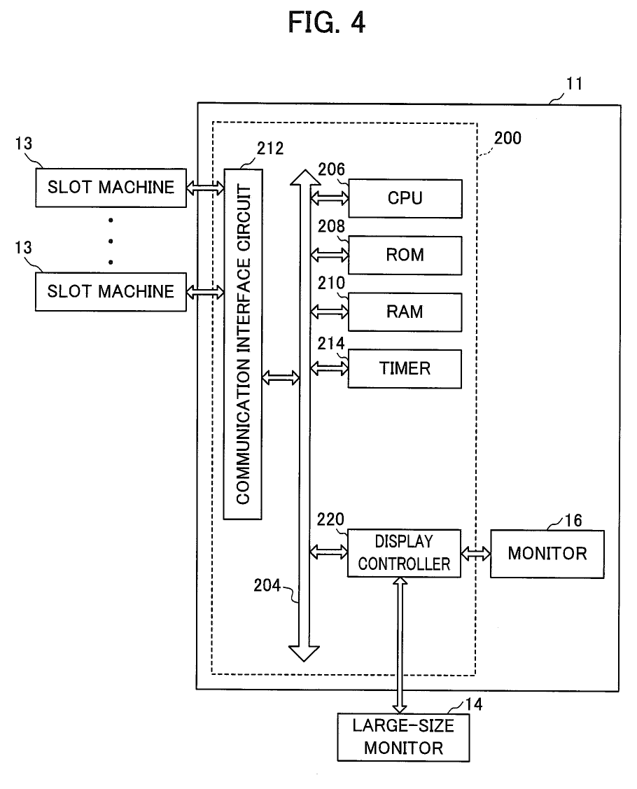

FIG. 4 is a block diagram showing an electrical configuration of the central controller 11. As shown in FIG. 4, the central controller 11 includes the controller 200 of the central controller 11 and several peripheral devices. Furthermore, a plurality of the slot machines 13 (five slot machines in the embodiment) and the large-size monitor 14 are connected with the central controller 11 via the communication interface circuit 212 of the central controller 11.

Furthermore, the controller 200 of the central controller 11 includes an input/output bus 204, a CPU 206, ROM 208, RAM 210, a communication interface circuit 212, a timer 214, and a display controller 220.

The ROM 208 and the RAM 210 are connected to the input/output bus 204.

The CPU 206 performs various types of processing according to an input signal supplied from each of the slot machines 13, and data and programs stored the ROM 208 and the RAM 210. Furthermore, the CPU 206 transmits command signals to the slot machines 13 based upon the results of the processing thus performed. Thus, the CPU 206 centrally controls each of the slot machines 13, thereby advancing the game. Then, the CPU 206 determines whether a combination formed by symbol data thus obtained from each of the slot machines 13 corresponds to a specified combination for providing an award. In a case where the CPU 206 determines that the combination formed by symbol data thus obtained from each of the slot machines 13 corresponds to a specified combination for providing an award, the CPU 206 transmits a signal for providing an award corresponding to the specified combination to each of the slot machines 13.

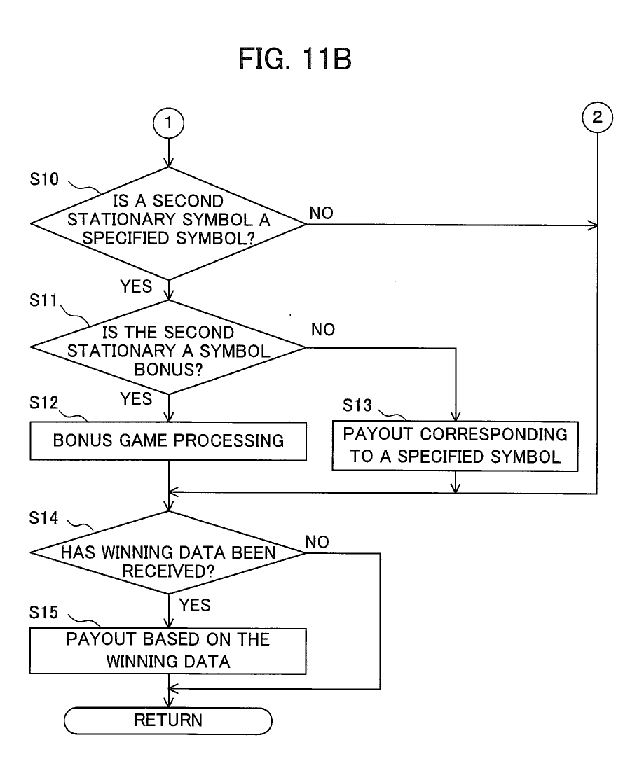

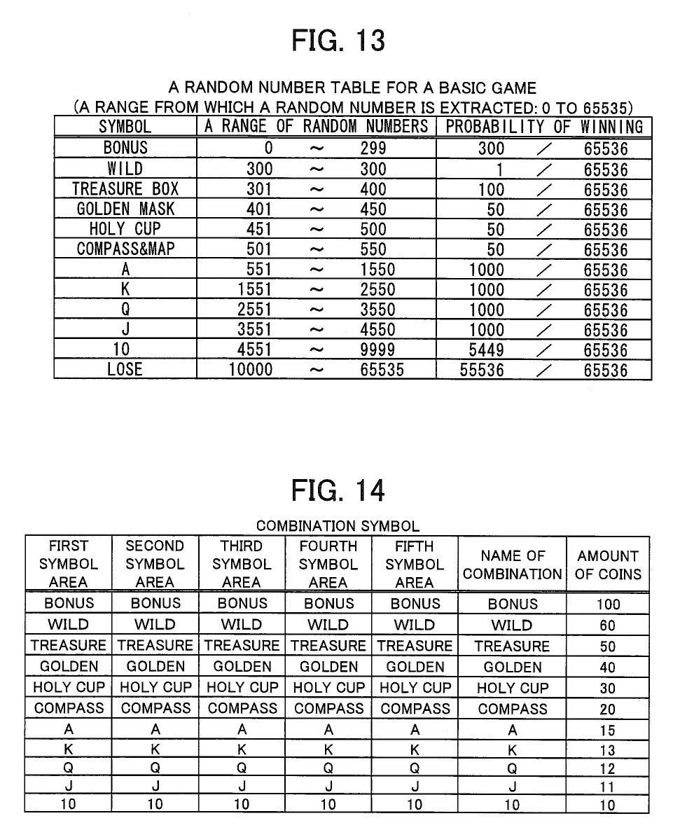

The ROM 208 includes solid-state memory or the like, for example. The ROM 208 stores a program for advancing a game, a program for realizing functions of the large-size monitor 14, a program for centrally controlling each of the slot machines 13, and the line. Examples of such programs include a program shown in FIG. 12. Furthermore, the ROM 208 stores a table for determining whether a combination corresponds to a specified combination or not (for example, FIG. 14).

On the other hand, the RAM 210 temporarily stores signal data transmitted from the slot machines 13, data regarding winning numbers corresponding to specified combinations, and the like.

The timer 214 for performing time measurement is connected to the input/output bus 204. The time information supplied from the timer 214 is transmitted to the CPU 206 via the input/output bus 204. As described later, for example, the CPU 206 makes a determination regarding the information input from the slot machines 13, based upon the time information received from the timer 214.

Furthermore, the display controller 220 is connected to the input/output bus 204. The CPU 206 performs various types of processing based upon the data and programs stored in the ROM 208 and the RAM 210. The CPU 206 controls the monitor 16 as a display unit of the large-size monitor 14 and the central controller 11, and displays images based upon the results of the processing thus performed.

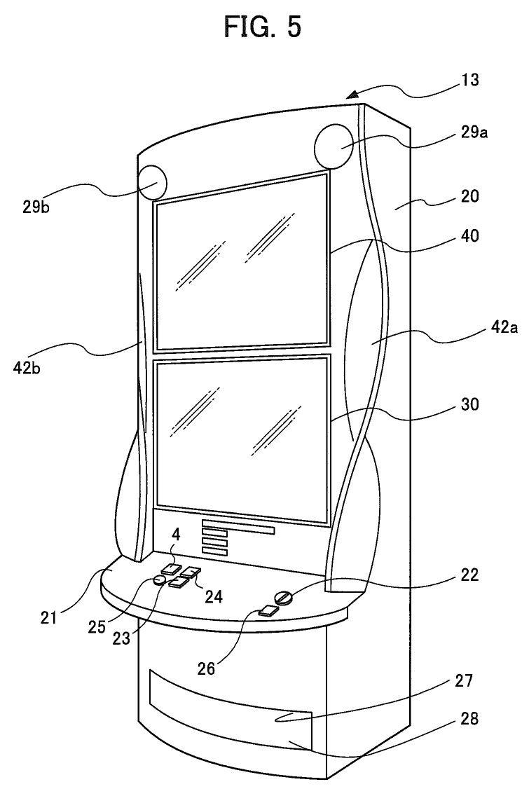

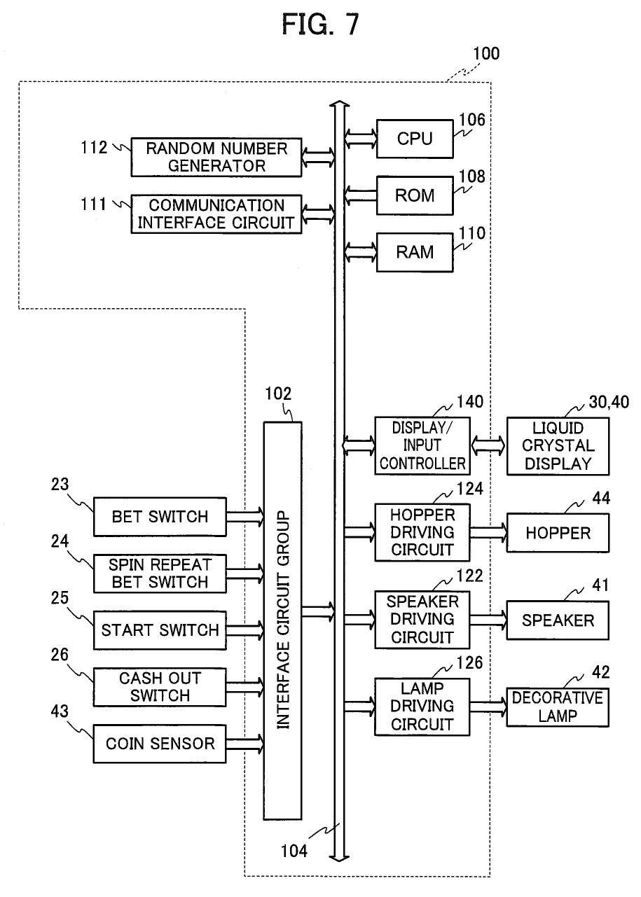

FIG. 5 is a perspective diagram illustrating the slot machine 13 in the gaming system 10 according to the present embodiment. The slot machine 13 includes a cabinet 20. The cabinet 20 has a structure in which the surface facing the player is open. The cabinet 20 houses various components including a game controller 100 (see FIG. 7) for electrically controlling the slot machine 13, and a hopper 44 (FIG. 7) for controlling the insertion, storage, and payout of coins (game media), and the like. The game medium is not restricted to coins. In addition, examples of such game media include medals, tokens, electronic money, or electronic value information (credit) having the same value.

The liquid crystal display 30 is installed substantially in the middle of the front surface of the cabinet 20, and the liquid crystal display 40 is installed in upper side of the cabinet 20.

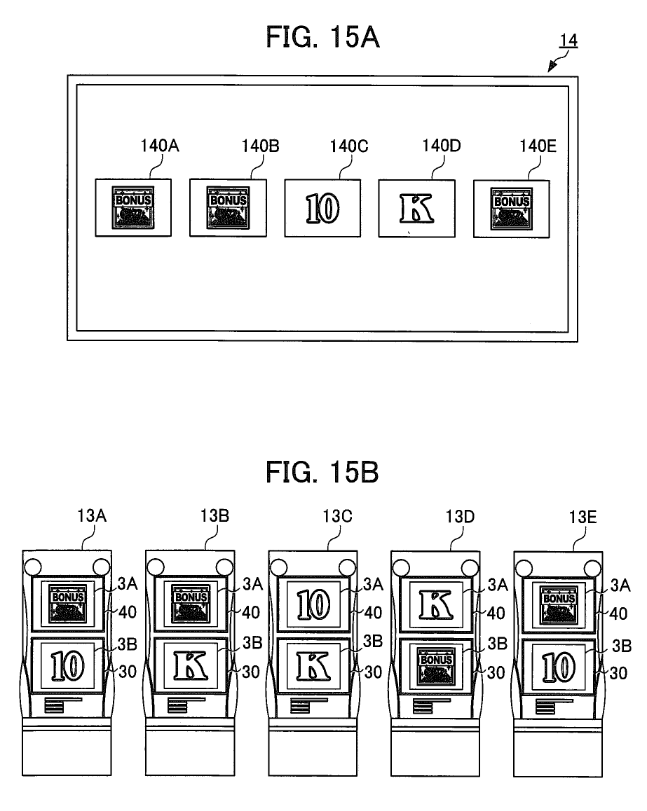

The liquid crystal displays 30 and 40 are employed as display units for displaying various images related to a game including rendered images and the like. Such a configuration allows the player to advance the game while visually confirming various types of images displayed on the liquid crystal displays 30 and 40. In such a game, the liquid crystal displays 30 and 40 can display a slot game as shown in FIGS. 15A and 15B.

In a configuration in which the slot machine 13 includes video reels 3A and 3B, each one virtual reel is displayed on the liquid crystal displays 30 and 40. It should be noted that the term “video reel” as used here represents a mechanism for displaying a reel on the liquid crystal displays 30 and 40 in the form of an image, instead of the mechanical reels. As a plurality of types of necessary symbols for the game, the following symbols of “BONUS”, “WILD”, “TREASURE BOX”, “GOLDEN MASK”, “HOLY CUP”, “COMPASS & MAP”, “SNAKE”, “A”, “K”, “Q”, “J”, and “10” are displayed together with images which appear rotating.

Referring to FIG. 5, sound transmission openings 29a and 29b are provided at both upper left and right sides of the liquid crystal display 40. Here, the sound transmission openings 29 are provided for transmitting sound effects generated by a speaker 41 (see FIG. 7) stored within the cabinet 20. The sound transmission openings 29a and 29b generate sound effects and the like in accordance with the progress of the game. Furthermore, decorative lamps 42a and 42b are disposed on the right and left sides substantially in the middle of the slot machine 13, respectively. The decorative lamps 42a and 42b emit light in accordance with the progress of the game.

The slot machine 13 includes a substantially horizontal operation unit 21 below the liquid crystal display 30. Furthermore, a coin insertion opening 22 is provided on the right side of the operation unit 21, which allows the player to insert coins. On its left side are disposed a bet switch 23 and a spin repeat bet switch 24. A player uses the bet switch 23 to select the amount of coins to bet on a game. The player uses the spin repeat bet switch 24 so as to keep the amount of coins to be bet in a subsequent game. In summary, pushing one of the bet switch 23 and the spin repeat bet switch 24 determines the amount of coins to be bet on a game corresponding to the pushing operation.

In the operating unit 21, a start switch 25 for accepting the player's operation of starting a game for each game is disposed on the left side of the bet switch 23. Upon performing the pushing operation on either the start switch 25 or the spin repeat bet switch 24, which serves as a trigger to start the game, the image that the aforementioned two video reels 3A and 3B start to rotate is displayed.

A cash out switch 26 is provided near the coin insertion opening 22 on the operation unit 21. Upon the player pushing the cash out switch 26, the inserted coins are paid out from a coin payout opening 27 provided at a lower portion of the front face. The coins thus paid out are retained in a coin tray 28.

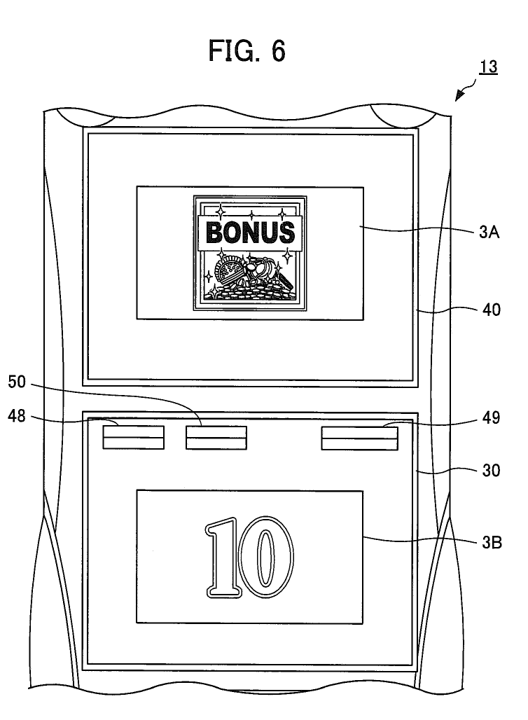

FIG. 6 is an enlarged view illustrating the display region of the slot machine 13. The video reel 3A is displayed in the liquid crystal display 40 on the slot machine 13, and the video reel 3B is displayed in the liquid crystal display 30 on the slot machine 13. In the present embodiment, one stationary symbol is displayed for each of the two video reels 3A and 3B.

If a player pushes the bet switch 23 once, one coin is inserted as a credit medal. If a player pushes the bet switch 23 twice, two coins are inserted as credit medals. If a player pushed the bet switch 23 three times, three coins are inserted as credit medals.

A game in which a player stops a specified symbol for providing an award in a so-called one reel slot (in this case, the video reel 3A and/or the video reel 3B) can be implemented in the present embodiment. In addition, a game in which a plurality of players form a symbol combination collectively using the game results of the plurality of slot machines through operations of the central controller 11 can be implemented in the present embodiment.

In addition, it is arranged so that a payout amount display unit 48, a bet amount display unit 50, and a credit amount display unit 49 can be displayed in this order from the left side on the upper part of the liquid crystal display 30. The payout amount display unit 48 is a component for displaying an amount of coins paid out when a stationary symbol corresponds to a specified symbol for providing an award. The credit number display unit 49 is a component for displaying the amount of coins retained in the slot machine 13 in the form of credits. The bet amount display unit 50 is a component for displaying the bet amount, which is the amount of coins bet.

FIG. 7 is a block diagram showing the electrical configuration of the game controller 100 of the slot machine 13. As shown in FIG. 7, the game controller 100 of the slot machine 13 is a microcomputer and is provided with an interface circuit group 102, an input/output bus 104, CPU 106, ROM 108, RAM 110, an interface circuit 111 for communication, a random number generator 112, a speaker drive circuit 122, a hopper drive circuit 124, a lamp drive circuit 126, and a display/input controller 140.

The interface circuit group 102 is connected with the input/output bus 104, which carries out the input and output of data signals or address signals for the CPU 106.

The start switch 25 is connected with the interface circuit group 102. In the interface circuit group 102, a start signal generated by the start switch 25 is converted into a predetermined form of signal to be supplied to the input/output bus 104.

Furthermore, the bet switch 23, the spin repeat bet switch 24, and the cash out switch 26 are connected to the interface circuit group 102. Each of the switching signals output from these switches 23, 24, and 26 is also supplied to the interface circuit group 102, and is converted into a predetermined signal by the interface circuit group 102. The switching signals thus converted are supplied to the input/output bus 104.

A coin sensor 43 is also connected with the interface circuit group 102. The coin sensor 43 detects coins inserted into the coin insertion slot 22, and is disposed at an appropriate position relative to the coin insertion slot 22. The sensing signal output from the coin sensor 43 is also supplied to the interface circuit group 102, and is converted into a predetermined signal by the interface circuit group 102. The sensing signal thus converted is supplied to the input/output bus 104.

The ROM 108 and the RAM 110 are connected to the input/output bus 104.

Upon acceptance of the start operation of a game through the start switch 25, the CPU 106 reads a game program to execute the game. The game program is programmed so that an image of the symbols on the video reels 3A and 3B starting rotation is displayed on the liquid crystal displays 30 and 40, respectively, via the display/input controller 140. Thereafter, an image that video reels 3A and 3B are stopped is displayed so as to rearrange the video reels 3A and 3B. In a case where the stationary symbol thus stopped corresponds to a specified symbol for providing an award, the game program is programmed so as to pay out an amount of coins corresponding to the specified stationary symbol for providing an award.

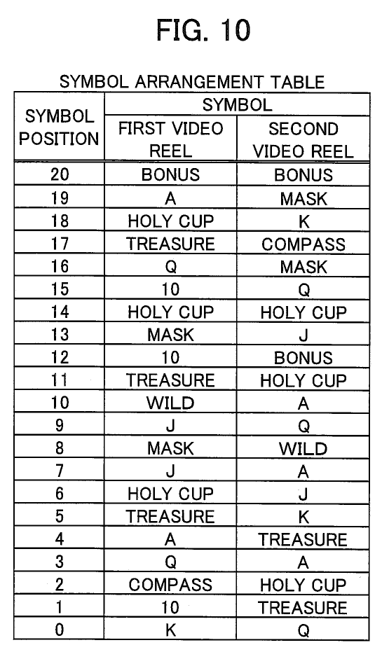

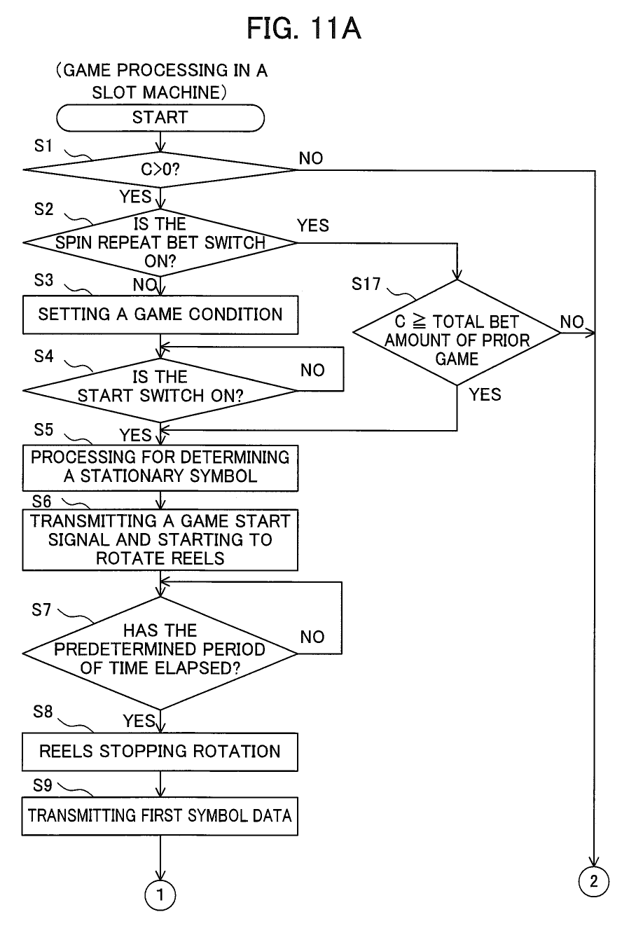

The ROM 108 stores: a control program for central control of the slot machine 13; a program for executing a routine shown in FIGS. 11 and 12 (which is referred to as the “routine execution program” hereafter); initial data for executing the control program; and various data tables used for determination processing. The routine execution program includes the abovementioned game program. Furthermore, tables as shown in FIGS. 10, 13, and 14 are examples of the data tables. The RAM 110 temporarily stores flags, variables, etc. used for the control program.

Furthermore, a communication interface circuit 111 is connected to the input/output bus 104. The communication interface circuit 111 is a circuit for communicating with the central controller 11, etc. via the network 12 including various types of networks such as LAN.

The random number generator 112 for generating a random number is connected to the input/output bus 104. The random number generator 112 generates random numbers in a predetermined range of “0” to “65535” (two to the sixteenth power minus one), for example. Alternatively, an arrangement may be made in which the CPU 106 generates a random number by computation processing.

The speaker drive circuit 122 for driving the speakers 41 is also connected with the input/output bus 104. The CPU 106 reads the sound data stored in the ROM 108 and transmits the sound data thus read to the speaker driving circuit 122 via the input/output bus 104. In this way, the speakers 41 generate predetermined sound effects.

The hopper drive circuit 124 for driving the hopper 44 is also connected with the input/output bus 104. Upon reception of a cash out signal input from the cash out switch 26, the CPU 106 outputs a driving signal to the hopper driving circuit 124 via the input/output bus 104. Accordingly, the hopper 44 pays out coins such that the amount thereof is equivalent to the current amount of coins remaining as credits, which is stored in a predetermined memory area of the RAM 110.

Alternatively, the payout of the coins may be performed in a mode of storing credit data in a data card or the like, instead of using real coins. In other words, the player may carry a card functioning as a recording medium, and store the data related to the credit by inserting the card into the slot machine 13.

The lamp drive circuit 126 for driving the decorative lamps 42a and 42b is also connected with the input/output bus 104. The CPU 106 transmits the signal for driving the lamps according to the predetermined conditions based on the program stored in the ROM 108 to the lamp driving circuit 126. Thus, decorative lamps 42a and 42b blink and the like.

The display/input controller 140 is connected to the input/output controller 140. The CPU 106 creates an image display command corresponding to the state and results of the game, and outputs the image display command thus created to the display/input controller 140 via the input/output bus 104. Upon reception of the image display command input from the CPU 106, the display/input controller 140 creates a driving signal for driving the liquid crystal displays 30 and 40 according to the image display command thus input, and outputs the driving signal thus created to the liquid crystal displays 30 and 40. As a result, a predetermined image is displayed on the liquid crystal displays 30 and 40. The display/input controller 140 transmits the signal input through the touch panel 32 provided on the liquid crystal displays 30 and 40 to the CPU 106 via the input/output bus 104 in the form of an input signal. In addition, the image display command includes commands corresponding to a payout amount display unit 48, a credit amount display unit 49, and a bet amount display unit 50.

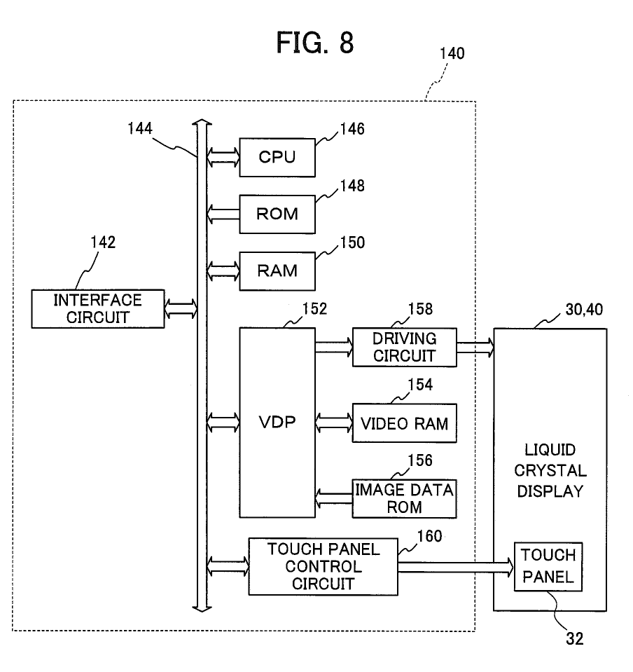

FIG. 8 is a block diagram showing an electric construction of the display/input controller 140 of the slot machine 13. The display/input controller 140 of the slot machine 13 is a sub-microcomputer for performing image display processing and input control for the touch panel 32. The display/input controller 140 includes an interface circuit 142, an input/output bus 144, CPU 146, ROM 148, RAM 150, VDP 152, video RAM 154, image data ROM 156, a driving circuit 158, and a touch panel control circuit 160.

The interface circuit 142 is connected to the input/output bus 144. An image display command output from the CPU 106 included in the game controller 100 is supplied to the input/output bus 144 via the interface circuit 142. The input/output bus 144 performs input/output of data signals or address signals for the CPU 146.

The ROM 148 and the RAM 150 are connected to the input/output bus 144. The ROM 148 stores a display control program for generating a driving signal, which is to be supplied to the liquid crystal displays 30 and 40, according to an image display command received from the CPU 106 included in the game controller 100. On the other hand, the RAM 150 stores flags and variables used in the display control program.

The VDP 152 is connected to the input/output bus 144. The VDP 152 includes a so-called sprite circuit, a screen circuit, a palette circuit, etc., and can perform various types of processing for displaying images on the liquid crystal displays 30 and 40. With such an arrangement, the components connected to the VDP 152 include: the video RAM 154 for storing image data according to the image display command received from the CPU 106 included in the game controller 100; and the image data ROM 156 for storing various types of image data including the image data for visual effects, etc. Furthermore, the driving circuit 158 for outputting a driving signal for driving the liquid crystal display 30 is connected to the VDP 152.

The CPU 146 instructs the video RAM 154 to store the image data which is to be displayed on the liquid crystal displays 30 and 40 according to the image display command received from the CPU 106 included in the game controller 100 by reading the display control program stored in the ROM 148 and by executing the program thus read. Examples of the image display commands include various types of image display commands including the image display commands for visual effects, etc.

The image data ROM 156 stores various types of image data including the image data for visual effects, etc.

The touch panel control circuit 160 transmits the signals input through the touch panel 32 provided on the liquid crystal displays 30 and 40 to the CPU 106 via the input/output bus 144 in the form of an input signal.

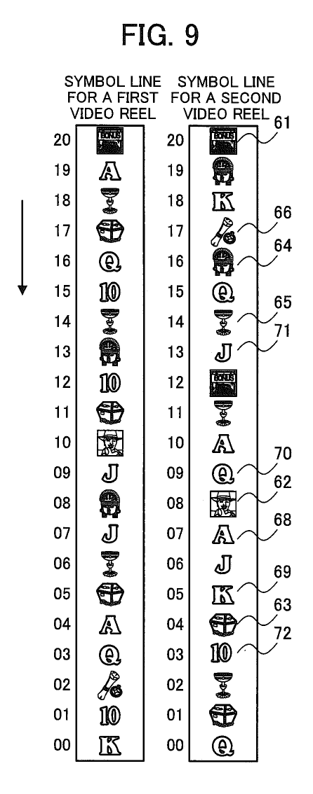

FIG. 9 shows symbol lines on which 21 symbols arranged on the video reels 3A and 3B are represented. In addition, the symbol line for a first video reel and the symbol line for a second video reel correspond to the video reels 3A and 3B, respectively.

Code numbers of “00” to “20” are referred to for each symbol of video reels 3A and 3B. These code numbers are converted to data in a data table so as to be stored in the ROM 108 (FIG. 7).

The symbol lines are represented on the video reels 3A and 3B, respectively. Specifically, the symbol lines are configured of “BONUS” symbol (symbol 61) (hereinafter abbreviated as “BONUS”), “WILD” symbol (symbol 62) (hereinafter abbreviated as “WILD”), “TREASURE BOX” symbol (symbol 63) (hereinafter abbreviated as “TREASURE BOX”), “GOLDEN MASK” symbol (symbol 64) (hereinafter abbreviated as “GOLDEN MASK”), “HOLY CUP” symbol (symbol 65) (hereinafter abbreviated as “HOLY CUP”), “COMPASS & MAP” symbol (symbol 66) (hereinafter abbreviated as “COMPASS & MAP”), “A” symbol (symbol 68) (hereinafter abbreviated as “A”), “K” symbol (symbol 69) (hereinafter abbreviated as “K”), “Q” symbol (symbol 70) (hereinafter abbreviated as “Q”), “J” symbol (symbol 71) (hereinafter abbreviated as “J”), and “10” symbol (symbol 72) (hereinafter abbreviated as “10”). The symbol lines on the video reels 3A and 3B can be moved by the display of an image where the reels 3A and 3B are rotating in a direction of the arrow shown in FIG. 9.

In the present embodiment, “BONUS”, “WILD”, “TREASURE BOX”, “GOLDEN MASK”, “HOLY CUP”, “COMPASS & MAP”, “A”, “K”, “Q”, “J”, and “10” are provided as hands that provide a predetermined award. A combination (combination data) is control information which correlates credits given to a player (the amount of payout of coins) to a combination of symbols for an award, and also which is used for stop control of each video reel 3A and 3B, change (shift) of a game state, payout of coins, and the like.

FIG. 10 shows a symbol arrangement table. The symbol arrangement table relates the code numbers indicating the position of each symbol constituting the symbol lines to each symbol of the respective video reels 3A and 3B, and then registers them. In addition, the first and second video reels correspond to the video reels 3A and 3B, respectively. In other words, the symbol arrangement table includes symbol information corresponding to the symbol position (the code number) of video reels 3A and 3B.

In FIG. 10, “TREASURE,” “MASK,” and “COMPASS” are abbreviations for the “TREASURE BOX,” “GOLDEN MASK,” and “COMPASS & MAP,” respectively.

FIGS. 11A and 11B are flowcharts showing the flow of the processing and the operation of the slot machine 13, which are executed by the game controller 100 of the slot machine 13. Executing the routines shown in FIGS. 11A and 11B once is equal to an execution of a unit game.

In addition, a description is provided below regarding a case in which the slot machine 13 has been activated beforehand. Furthermore, the variables used by the CPU 106 included in the game controller 100 have been initialized to predetermined values, thereby operating the slot machine 13 in a normal state.

First, the CPU 106 included in the game controller 100 determines whether or not any credits remain, which corresponds to the remaining amount of coins inserted by the player (Step Si). More specifically, the CPU 106 reads a credit amount C stored in the RAM 110, and executes processing according to the credit amount C. When the credit amount C equals “0” (NO in Step S1), the CPU 106 terminates the routine without executing any processing, since it cannot start a game. When the credit amount C is not less than “1” (YES in Step S1), the CPU 106 determines that coins remain as credits, and the CPU 106 moves the processing to Step S2.

In Step S2, the CPU 106 determines whether or not a pushing operation has been executed on the spin bet repeat switch 24. When the spin repeat bet switch 24 is pushed and an operation signal from the switch 24 is then input (when the result is YES in Step S2), the CPU 106 moves on to Step S17. On the other hand, when the CPU 106 does not receive the operation signal from the switch 24 after a predetermined period of time elapses (NO in Step S2), the CPU 106 determines that the switch 24 has not been pushed and moves the processing to Step S3.

In Step S3, the CPU 106 sets game conditions. More specifically, the CPU 106 determines the amount of coins bet in this game based on the operation of the bet switch 23. In Step S3, the CPU 106 receives signals indicative of operation performed on the bet switch 23, and controls the RAM 110 to store the bet amount in a predetermined memory area. The CPU 106 reads the credit amount C stored in a predetermined memory area of the RAM 110, and subtracts the total bet amount, which is the sum of the bet amounts, from the credit amount C thus read. Then, the CPU 106 stores the subtracted value in a predetermined memory area of the RAM 110. Subsequently, the CPU 106 moves the processing to Step S4.

In the following Step S4, the CPU 106 determines whether the start switch 25 has been activated, and then waits for the start switch 35 to be operated. Upon the start switch 25 being operated, and accordingly, upon the operation signal being input from the start switch 25 (in a case of “YES” in the determination processing in Step S4), the CPU 106 determines that the start switch 25 has been operated, and the flow proceeds to Step S5.

On the other hand, upon moving from Step S2 to Step S17, the CPU 106 determines whether or not the credit amount C is equal to or greater than the total bet amount in a previous game. In other words, the CPU 106 determines whether it can start a game in response to a pushing operation executed on the spin repeat bet switch 24. More specifically, when the spin repeat bet switch 24 is pushed and an operation signal coming from the switch 24 enters the CPU 106, the CPU 106 reads the credit amount C and the bet amount. The CPU 106 performs subsequent processing according to whether or not the current credit amount C is equal to or greater than the total bet amount for the previous game based on both the credit amount C and the bet amount. When the CPU 106 determines that the former value is less than the latter value (when the result is NO in Step S17), the CPU 106 cannot start any game, and therefore terminates the present routine without performing any processing. On the other hand, when the former value is not less than the latter value (when the result is YES in Step S17), the CPU 106 subtracts the value of the total number bet in the previous game from the value of the credit amount C, and causes the resulting value to be stored in a predetermined memory area of the RAM 110. Subsequently, the CPU 106 moves the processing to Step S5.

In the following Step S5, the CPU 106 performs processing for determining a stationary symbol. A specific description is made below regarding processing for determining a stationary symbol.

Firstly, in processing for determining a stationary symbol, the CPU 106 determines a stationary symbol on each of video reel 3A and 3B. Specifically, the CPU 106 issues a command for the random number generator 112 to generate a random number, thereby extracting a random number in a predetermined range (in a range of “0” to “65535” in the present embodiment) generated by the random number generator 112. The CPU 106 stores the random number thus extracted in a predetermined memory area of the RAM 110. It should be noted that a description is provided in the present embodiment regarding an arrangement in which the random number is generated by the random number generator 112, which is a separate component from the CPU 106. In addition, an arrangement may be made in which the random number is generated by computation processing by the CPU 106 without involving the random number generator 112.

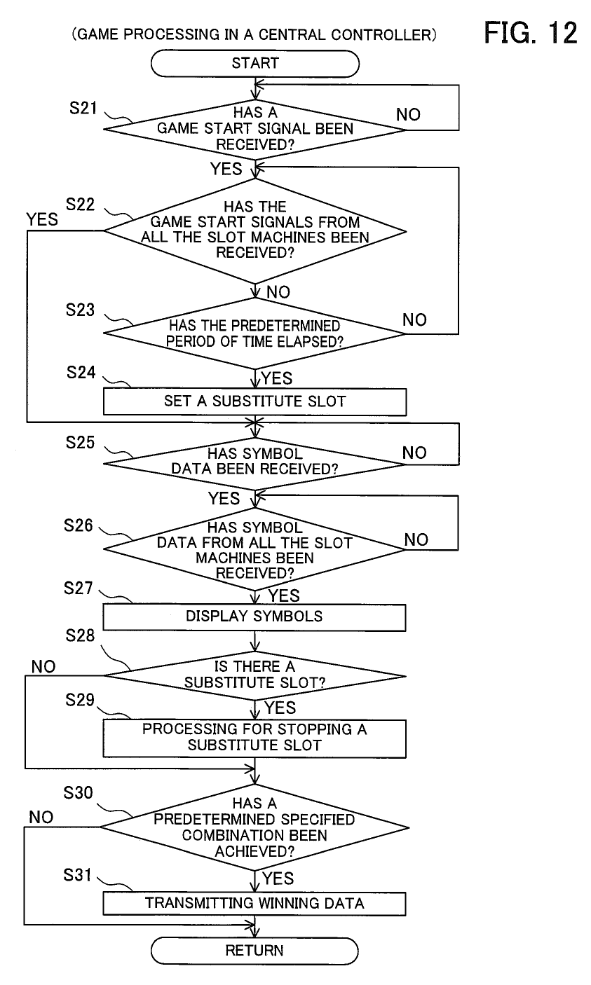

Next, in the Step S5, the CPU 106 reads a random number table for a basic game (see FIG. 13) stored in the ROM 108 and stores it in a predetermined memory region in the RAM 110. The random number table for a basic game includes specified symbols for providing an award and a random number table, and correlates each specified symbol to a random number range of the random number table. This process is described further below. Then, the CPU 106 reads random number values and the random number table for a basic game from the predetermined memory area in the RAM 110, and determines a stationary symbol. The stationary symbol is determined for each of video reel 3A and 3B respectively in the same way.

Upon determining a stationary symbol, the CPU 106 stores the symbol data thus determined related to a stationary symbol in a predetermined memory area of the RAM 110. In this stage, a symbol arrangement table (see FIG. 10) stored in the ROM 108 is read by the CPU 106. The symbol arrangement table thus read is stored in a predetermined memory area of the RAM 110, and used as reference data. The CPU 106 stores the data for the stationary symbols thus determined in a predetermined memory area of the RAM 110.

When the CPU 106 determines a stationary symbol, the CPU 106 determines whether the stationary symbol on the video reel 3B (hereinafter, a second stationary symbol) corresponds to a specified symbol for providing an award. In a case where the second stationary symbol corresponds to a specified symbol for providing an award, the CPU 106 activates a flag which indicates to provide an award. The flag indicates the types of specified symbols for providing an award. When a stationary symbol corresponds to a specified symbol for providing an award, the flag is activated for generating the corresponding award. The activated flag, which indicates the player has won an award, is stored in a predetermined area of the RAM 110 according to the instruction from the CPU 106. On the other hand, in a case where the stationary symbol corresponds to a losing symbol, the CPU 106 does not activate a flag indicating to provide an award. Subsequently, the CPU 106 moves the processing to Step S6.

In the following Step S6, the CPU 106 displays an image of the video reels 3A and 3B starting to rotate, as well as transmitting to the central controller 11 a game start signal indicating that the game starts. More specifically, the CPU 106 displays an image showing the video reels 3A and 3B rotating, in sequence or simultaneously, based upon the symbol arrangement table stored in the RAM 110, as well as transmitting a game start signal to the central controller 11.

Upon displaying the image showing the video reels 3A and 3B starting to rotate, the CPU 106 waits for a predetermined period of time to elapse (Step S7). After the predetermined period of time has elapsed (in a case of “YES” in the determination processing in Step S8), the CPU 106 instructs the video reels 3A and 3B to automatically stop rotating (Step S8). More specifically, the CPU 106 controls each of the video reels 3A and 3B to stop sequentially or simultaneously such that the stationary symbols thus determined in Step S5 are displayed within a display region which a player can visually recognize. Subsequently, the CPU 106 moves the processing to Step S9.

In Step S9, the CPU 106 transmits symbol data indicating a stationary symbol on the video reel 3A (hereinafter, a first stationary symbol) to the central controller 11. When this processing is terminated, the CPU 66 advances the processing to Step S10 (FIG 11B).

In Step S10, the CPU 106 determines whether or not the second stationary symbol corresponds to a specified symbol for providing an award. More specifically, the CPU 106 makes the determination based on the status of the flag indicating to provide an award, which is stored in the predetermined memory area of the RAM 110. In a case where the flag, which indicates that the player has won an award, has not been activated, i.e. in a case where a symbol for providing an award corresponds to a “lose” symbol (in a case of “NO” in the determination processing in Step S10), the CPU 106 determines that the symbol does not correspond to the specified symbol for providing an award and proceeds to Step S14. On the other hand, in a case where the flag, which indicates that the player has won an award, has been activated, i.e. in a case where a symbol does not correspond to a “lose” symbol (in a case of “YES” in the determination processing in Step S10), the processing proceeds to Step S11 according to the instruction from the CPU 106.

In the following Step S11, the CPU 106 determines whether the second stationary symbol thus formed based upon processing for determining a stationary symbol performed in Step S5 is a “BONUS”. More specifically, in a case where the specified symbol is “BONUS”, which provides an award (in a case of “YES” in the determination processing in Step S11), the CPU 106 advances the flow to Step S12. On the other hand, in a case where a specified symbol for providing an award is not “BONUS” (NO in Step S11), the CPU 106 moves to Step S13.

In the following Step S12, the CPU 106 performs bonus game processing. More specifically, the CPU 106 starts a bonus game so as to perform a predetermined number of bonus games. When the processing is terminated, the CPU 106 moves the processing to Step S14.

In a case where the flow has proceeded to Step S13, the CPU 106 pays out an amount of coins corresponding to the specified symbol for providing an award. More specifically, the CPU 106 refers to a payout table (not shown) and calculates a payout amount of coins corresponding to the specific combination for providing the award. The CPU 106 reads the credit amount stored in the predetermined memory area of the RAM 110. Then, the CPU 106 calculates the sum total amount of coins to be paid out thus calculated and the credit amount thus read, and stores the sum thus calculated in a predetermined memory area of the RAM 110. The CPU 106 displays the sum thus stored on the credit amount display unit 49. Subsequently, the flow proceeds to Step S14 according to the instruction from the CPU 106.

Upon moving to Step S14 in FIG. 11B, the CPU 106 transmits data of a game result to the central controller 11. Winning data is transmitted when the central controller 11 determines that a specified combination, which is described later, has been achieved. This process is described further below. In a case where the winning data is received (YES determination in Step S14), the CPU 106 moves the processing to Step S15. In a case where the winning data is not received (NO determination in Step S14), the CPU 106 terminates the present routine.

In a case where the flow has proceeded to Step S15, the CPU 106 pays out an amount of coins corresponding to the winning data. That processing is similar to that of Step S13. Subsequently, the CPU 106 terminates the routine.

FIG. 12 is a flowchart showing processing operation of the central controller 11, which is performed by the controller 200 of the central controller 11.

In the description below, the central controller 11 has been activated previously, and variables used in the CPU 206 included in the controller 200 have been initialized at a predetermined value, whereby the central controller 11 has been activated in a normal state.

First, the CPU 206 of the central controller 11 determines whether a game start signal has been received from any one of a plurality of slot machines 13 (Step S21). In the present embodiment, game start signals are received from five slot machines 13A, 13B, 13C, 13D, and 13E. When a game start signal is received from any one of the five slot machines 13A, 13B, 13C, 13D, and 13E (in a case of YES determination in Step S21), the CPU moves the processing to Step S22. On the other hand, when a game start signal is not received from any one of the five slot machines 13A, 13B, 13C, 13D, and 13E (in a case of a NO determination in Step 21), the CPU 206 waits ready. In addition, a game start signal includes at least a signal indicating that a game started and an address of a slot machine which transmitted the signal.

In Step S22, the CPU 206 determines whether to have received the game start signals from all of the five slot machines 13A, 13B, 13C, 13D, and 13E. More specifically, each time the CPU 206 receives a game start signal from a slot machine 13, the CPU 206 stores in the RAM 210 the address of the slot machine 13 which transmitted the game start signal. When the addresses of all of the five slot machines are stored in the RAM 210 (in a case of YES determination in Step S22), the CPU moves the processing to Step S25. Furthermore, when the addresses of all the five slot machines are not stored in the RAM 210 (in a case of a NO determination in Step S22), the CPU moves the processing to Step S23. In addition, in the processing of Steps S21 and S22, the CPU 206 starts to display an image of a reel rotating, such as rotation of video reels 3A and 3B of the slot machine 13, on the symbol display region in the large-size monitor 14. The symbol display area in the large-size monitor 14 corresponds to the slot machine 13 that receives a game start signal. In this case, the CPU 206 starts to display an image of rotation on the large-size monitor in response to reception of a game start signal (in the order of reception).

In Step S23, the CPU 206 determines whether or not a predetermined time has elapsed. More specifically, the CPU 206 measures the amount of time required in processing of Step S21 using a timer 214 and determines whether a predetermined amount of time has elapsed. In a case where the CPU determines that a predetermined amount of time has elapsed (in a case of NO determination in Step S23), the CPU moves the processing to Step S22. On the other hand, in a case where a predetermined amount of time has elapsed (in a case of a YES determination in Step S23), the CPU moves the processing to Step S24.

In Step S24, the CPU 206 sets a substitute slot. More specifically, the CPU 206 sets a substitute slot related to a slot machine 13 which does not receive a game start signal. It is because the CPU 206 determines a symbol displayed in a symbol area on the large-size monitor 14 corresponding to a slot machine 13 which does not receive a game start signal, and displays it. More specifically, the CPU 206 activates a substitute flag in order to determine a symbol related to a slot machine 13 for which an address is not stored in the RAM 210, and stores it in a predetermined storage area. When this processing is terminated, the CPU 206 advances the processing to Step S25. In addition, in a case where there is a plurality of slot machines 13 for which addresses are not stored in the RAM 210, the number of the substitute flag is stored corresponding to the number of the slot machine 13.

In Step S25, the CPU 206 determines whether it has received symbol data from a slot machine 13. More specifically, in Step S22, the CPU 206 determines whether it has received symbol data from any one of slot machines 13 which addresses are stored in the RAM 210. In a case where the CPU 206 has received symbol data (in a case of a YES determination in Step S25), the CPU 206 moves the processing to Step S26. On the other hand, in a case where the CPU 206 has not received symbol data (in a case of a NO determination in Step S25), the CPU 206 waits ready. In addition, in a case where the CPU 206 has received symbol data, the CPU 206 stores it in a predetermined storage area.

In Step S26, the CPU 206 determines whether to have received symbol data from all of the slot machines 13 which have received a game start signal. More specifically, the CPU 206 compares an address of a slot machine 13 which is stored in the PAM 210 with an address of a slot machine 13 which has received symbol data in Step S26, and determines whether those addresses are identical or not. Then, in a case where the CPU 206 determines that all of the addresses stored in the RAM 210 are identical (in a case of a YES determination in Step S26), the CPU 206 stores symbol data in a predetermined storage area in the RAM 210 and moves the processing to Step S27. Furthermore, in a case where the CPU 206 does not determine that all the addresses stored in the RAM 210 are identical (in a case of a NO determination in Step S26), the CPU 206 waits ready.

In Step S27, the CPU 206 displays symbols on symbol display regions 140A to 140E (see FIG. 15A) in the large-size monitor 14. More specifically, the CPU 206 displays a symbol corresponding to symbol data thus received on the large-size monitor 14 in response to reception of the symbol data. On the large-size monitor 14, spaces for displaying symbols are defined for each of the slot machines which receive symbol data. On the symbol display regions 140A to 140E as the spaces corresponding to the slot machines 13 which receive symbol data, each symbol corresponding to symbol data thus received from the slot machines 13 is displayed, respectively. It is preferred that the processing is performed every time symbol data are received from a plurality of slot machines 13.

In Step S28, the CPU 206 determines whether to have set a substitute slot. More specifically, the CPU 206 determines whether a substitute flag stored in a predetermined storage area in the RAM 210 has been activated. In a case where the substitute flag has been activated (in a case of a YES determination in Step S28), the CPU moves the processing to Step S29. On the other hand, in a case where the substitute flag has not been activated (in a case of a NO determination in Step S28), the CPU moves the processing to Step S30.

In Step S29, the CPU 206 stops a substitute slot. More specifically, a symbol which the CPU 206 displays is determined in relation to a display region in the large-size monitor 14 corresponding to a slot machine 13 which has not received a start signal, and the symbol which is displayed as being rotated is displayed to be stopped. The symbol displayed to be stopped is determined as follows.

Firstly, the CPU 206 generates random numbers by computation processing. A table (not shown) which is similar to a random number table for a basic game stored in the ROM 108 of the slot machine 13 is stored in the ROM 208 of the central controller 11. Then, the CPU 206 determines a symbol to be displayed based on a random number value and the table. The processing for determining a symbol is similar to Step S5 in FIG. 11A. When this processing is terminated, the CPU 206 advances the processing to Step S30.

In Step S30, the CPU 206 determines whether a specified combination is achieved or not. More specifically, the CPU 206 determines whether a combination formed by symbols displayed on the large-size monitor 14 correspond to a specified combination for providing an award. More specifically, the CPU 206 determines whether a combination formed by a plurality of symbol data transmitted from a plurality of slot machines 13 corresponds to a specified combination based on a combination table (FIG. 14) stored in the ROM 208. In a case where the CPU 206 determines that the combination formed by a plurality of symbol data corresponds to a specified combination (in a case of a YES determination in Step S30), the CPU 206 moves the processing to Step S31. On the other hand, in a case where the combination formed by a plurality of symbol data does not correspond to a specified combination (in a case of a NO determination in Step S30), the CPU 206 terminates the processing.

In Step S31, the CPU 206 creates winning data and transmits it to a slot machine 13. Winning data includes at least data of the amount of coins paid out as an award corresponding to a specified combination thus determined in Step S30. Then, the CPU 206 transmits the winning data to a slot machine 13 which has received a game start signal. More specifically, the CPU reads an address of a slot machine 13 stored in a predetermined storage area in the RAM 210, and transmits the winning data to each of slot machines 13 based on the address thus read. When this processing is terminated, the CPU 206 terminates the present routine.

A random number table for a basic game is described with reference to FIG. 13. In the random number table for a basic game, a range of random numbers and the probability of winning are registered in association with each of specified symbols for providing an award. Therefore, when processing for determining a stationary symbol (Step S5 in FIG. 11A), and a random number is extracted, for example, in the range of “0” to “299” among the random numbers “0” to “65535,” it can be determined in the slot machine 13 to stop a specified symbol for providing the award of “BONUS”, as a game result. In other words, the probability that a combination formed by stationary symbols is determined as the specified combination for providing the award of “BONUS” is “300/65536”.

A combination table is described with reference to FIG. 14. The combination table is stored in the ROM 208 of the central controller 11. In the combination table, a combination of symbols displayed in each of the symbol display regions 140A to 140E is associated with the amount of coins as an award. For example, in a case where all the stationary symbols displayed on the large-size monitor 14 are “GOLDEN”, a combination of “GOLDEN” is achieved, and the winning data including a value of 40 coins (data of an amount of credits inserted in the form of coins) is transmitted.

FIGS. 15A and 15B are diagrams for displaying stationary symbols on five slot machines 13A, 13B, 13C, 13D, and 13E, and a large-size monitor 14 in the present embodiment. Thus, rotation of the video reels 3A and 3B, which are displayed on the liquid crystal displays 30 and 40, respectively, is displayed as being stopped on the five slot machines 13A, 13B, 13C, 13D, and 13E, whereby stationary symbols are displayed (FIG. 15B). In addition, each symbol display region 140A, 140B, 140C, 140D, and 140E is provided on the large-size monitor 14, each of which corresponds to each of the slot machines 13A, 13B, 13C, 13D, and 13E. The symbol display region 140A corresponds to the slot machine 13A. The symbol display area 140B corresponds to the slot machine 13B. The symbol display area 140C corresponds to the slot machine 13C. Furthermore, The symbol display area 140D corresponds to the slot machine 13D. The symbol display area 140E corresponds to the slot machine 13E. Stationary symbols (first stationary symbols), which are displayed on each of the video reels 3A, are displayed on each of the corresponding slot machines 13A, 13B, 13C, 13D, and 13E, each of which corresponds to the symbol display area 140A, 140B, 140C, 140D, and 140E, respectively (FIG. 15A). The CPU 206 determines whether the combination formed by the symbols displayed on the large-monitor 14 corresponds to a specified combination for providing an award.

According to the abovementioned embodiment, an award is provided to a player by a single slot machine 13, and moreover, an award is also provided to a player by a plurality of slot machines 13 by collaboratively forming one combination. Accordingly, it allows a plurality of players to play a game in collaboration with each other. Therefore, it can provide players' collaborative play which is a novel entertainment characteristic in a game which a slot machine 13 offers.

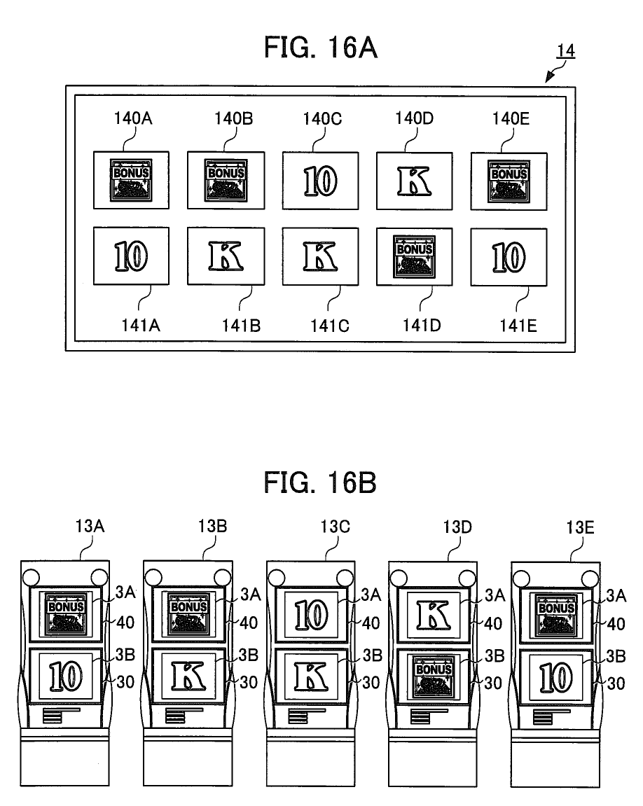

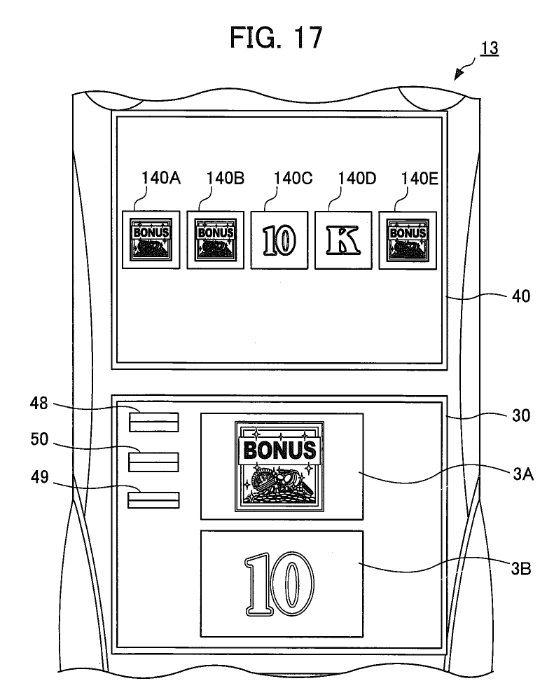

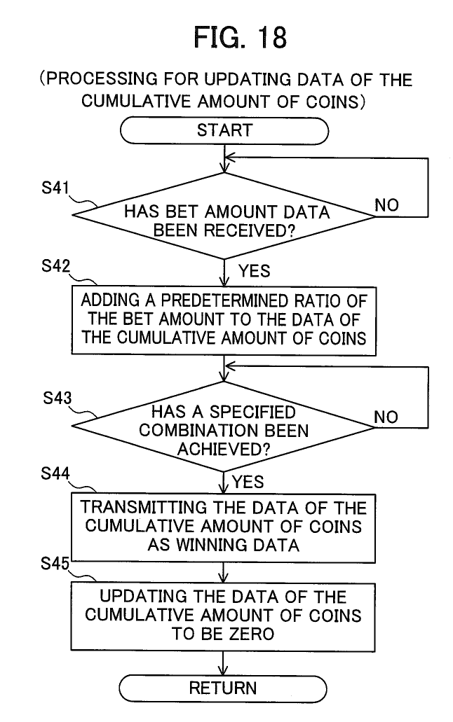

Next, a description is provided regarding variation examples according to the present embodiment. A first variation example is a combination formed by symbols displayed on the large-size monitor 14 (FIGS. 16A, 16B). A second variation example is regarding a display form of symbols corresponding to symbol data transmitted from the central controller 11 (FIG. 17). A third variation example is to determine coin amount data included in winning data of the central controller 11 (FIG. 18). In addition, a description is mainly given regarding different components compared to the abovementioned embodiment in the following variation examples. Components with no description are similar to those of the abovementioned embodiment. In addition, the same reference numbers are employed for the corresponding components of the abovementioned embodiment.

The first variation example is described with reference to FIGS. 16A and 16B. The first variation example is different from the abovementioned embodiment in that data for two stationary symbols are included in symbol data transmitted to the central controller 11.

Symbol data transmitted to the central controller 11 includes the first symbol data for a first stationary symbol and the second symbol data for a second stationary symbol. The first stationary symbol indicates a stationary symbol on the video reels 3A of the slot machine 13. Then, symbol data of the first stationary symbol are referred to as the first symbol data. The second stationary symbol indicates a stationary symbol on the video reels 3B of the slot machine 13. Then, symbol data of the second stationary symbol are referred to as the second symbol data.

When the central controller 11 receives symbol data, the central controller 11 stores the first symbol data and the second symbol data in the predetermined storage area of the RAM 210 (corresponding to Steps S25 and S26 in FIG. 12). Then, symbols corresponding to the first symbol data and the second symbol data are each displayed on the large-size monitor 14 (corresponding to Step S27 in FIG. 12).

Symbol display areas 141A, 141B, 141C, 141D, and 141E as well as 140A, 140B, 140C, 140D, and 140E are provided on the large-size monitor 14, each of which corresponds to the slot machines 13A, 13B, 13C, 13D, and 13E, respectively. The symbol display areas 140A, 140B, 140C, 140D, and 140E display symbols corresponding to the first symbol data. In other words, stationary symbols of the video reels 3A of the slot machines 140A, 140B, 140C, 140D, and 140E are displayed. Furthermore, the symbol display areas 141A, 141B, 141C, 141D, and 141E display symbols corresponding to the second symbol data. In other words, stationary symbols of the video reels 3B of the slot machines 140A, 140B, 140C, 140D, and 140E are displayed.

Consequently, there are two lines in order to determine whether a combination displayed on the large-size monitor 14 corresponds to a specified combination. Then, the central controller 11 determines whether each of the combinations formed on these two lines corresponds to a specified combination (corresponding to Step S30 in FIG. 12).

Furthermore, in the slot machines 13, the central controller 11 determines whether each of the first stationary symbol and the second stationary symbol (stationary symbols on both of the video reels 3A and 3B) corresponds to a specified symbol for providing an award (corresponding to Step S27 in FIG. 11B).

With the configuration such as the first variation example, the opportunities to determine whether to correspond to a specified combination and a specified symbol in a single unit game can be increased. Consequently, it can provide a gaming system having novel entertainment characteristics.

The second variation example is described with reference to FIG. 17. The second variation example is different from the abovementioned embodiment in that a combination formed by a plurality of symbols corresponding to symbol data transmitted to the central controller 11 is displayed on the liquid crystal display 40 of the slot machine 13 without having the large-size monitor 14.

FIG. 17 is a display example of the liquid crystal displays 30 and 40 of the slot machine 13. The video reels 3A and 3B are displayed on the liquid crystal display 30. Then, a combination transmitted from the central controller 11 is displayed on the liquid crystal display 40.

The CPU 206 of the central controller 11 stores symbol data until the CPU 206 receives symbol data from all of the slot machines 13 (corresponding to Steps S25 and S26 in FIG. 12) or determines symbols by a substitute slot (corresponding to Step S29 in FIG. 12) in regards to symbols displayed on the video reels 3A of each of the slot machines 13. When the five symbols are determined, the CPU creates combination data formed by symbols (data) stored in the RAM 210 and transmits the data to each of the slot machines 13. In addition, the CPU may transmit symbol data to the slot machines 13 every time the CPU receives the symbol data from each of the slot machines 13. Alternatively, the slot machines 13 which receive combination data may display each of the symbols on the liquid crystal display 40 at a predetermined time interval.

Furthermore, the CPU 206 of the central controller 11 determines whether a combination formed by symbols (data) stored in the RAM 210 corresponds to a specified combination (corresponding to Step S30 in FIG. 12). In a case where the combination formed by symbols stored in the RAM 210 corresponds to a specified combination, the CPU 206 transmits winning data to the slot machine 13 (corresponding to Step S 31 in FIG. 12). This processing is similar to the processing described in the abovementioned embodiment.

With the configuration of the second variation example, locational restrictions regarding a game which the gaming system 10 offers can be overcome. For example, by establishing a network 12 which can be connected from a certain region or amusement facilities from all over the world, slot machines 13 for participation to the game among slot machines from a certain region or all over the world can be arbitrarily selected, thereby providing a game which the gaming system 10 executes. In this case, it is preferred that one group is formed by a plurality of slot machines 13 which received a game start signal within a predetermined amount of time so that the group thus formed participates in a unit game collectively. Alternatively, slot machines 13 connecting to the network 12 may be randomly selected in order to give participation access to the game.

The third variation example is described with reference to FIG. 18. The third variation example is different from the abovementioned embodiment in that a combination table is not used in order to determine an amount of coins provided to a player as an award in a case where a combination formed by a plurality of symbols corresponding to symbol data transmitted to the central controller 11 corresponds to a specified combination.

FIG. 18 is a flowchart of processing for the central controller 11 to determine the amount of coins provided to a player as an award.

In Step S41, the CPU 206 of the controller 200 in the central controller 11 receives the bet amount data from the slot machine 13. More specifically, the CPU 106 of the game controller 100 in the slot machine 13 transmits a value of an amount of credits which is an amount of coins bet (data of an amount of credits inserted in the form of coins) to the central controller 11 as bet amount data through pushing of a bet switch 24. Then, the CPU 206 receives the bet amount data transmitted from the slot machine 13, and stores it in a predetermined storage area in the RAM 210 (YES in step 41). When this process is terminated, the CPU 206 moves the processing to Step S42. On the other hand, when the CPU 206 has not been received the bet amount data, the CPU 206 was ready (NO in step 41).

In Step S42, the CPU 206 reads the bet amount data stored in the RAM 210, calculates a predetermined ratio of the value indicated by the bet amount data, and adds the value thus calculated to the data of the cumulative amount of coins. The data of the cumulative amount of coins is referred to as data which is cumulatively added with a predetermined ratio of the value indicated by the bet amount data transmitted from each of the slot machines 13. The data of the cumulative amount of coins is stored in a predetermined storage area in the RAM 210. A predetermined ratio can be set arbitrarily. When this processing is terminated, the CPU 206 moves the processing to Step S43.

In Step S43, the CPU 206 determines whether a symbol combination is achieved or not. This determination is similar to that of the abovementioned embodiment (processing of Step S30 in FIG. 12). In a case of a YES determination, the CPU 206 moves the processing to Step S44. On the other hand, in a case of a NO determination, the CPU 206 waits ready.

In Step S44, the CPU 206 transmits the data of the cumulative amount of coins as winning data. More specifically, the CPU 206 reads the data of the cumulative amount of coins stored in the RAM 210, and transmits it as winning data to the slot machine 13. In a case where a value is after the decimal point regarding the value indicated by the data of the cumulative amount of coins, it is preferred to truncate, round out, or round off decimal points so as to be a positive integer. When this process is terminated, the CPU 206 moves the processing to Step S45.

In Step S45, the CPU 206 updates the data of the cumulative amount of coins to zero. More specifically, the CPU 206 reads the data of the cumulative amount of coins stored in the RAM 210, updates the data of the cumulative amount of coins to be zero, and stores it in the RAM 210. When this processing is terminated, the CPU terminates the present routine.

With the configuration of the third variation example, the amount of coins provided to a player as an award is always changed in a case where a combination corresponds to a specified combination. Thus, in a case where a combination does not correspond to a specified combination for long periods of time, it is possible to provide a great award to a player. Consequently, it can enhance a player's expectation regarding a great award which a player can get, and it can also provide novel entertainment characteristics by which a player can get different awards depending on situations during the same game.

In addition, although in the third variation example, a predetermined ratio of the bet amount is added to the data of the cumulative amount of coins, it is not limited thereto. For example, a predetermined ratio of coins provided as an award may be added to the data of the cumulative amount of coins.

In addition, the third variation example can be combined with the first or second variation examples as well as the abovementioned embodiment so as to be implemented.

While the gaming system according to the present invention has been described above by way of embodiments, it should be clearly understood that the embodiments in no way restrict the present invention, and that the specific configurations such as the means and components may be modified and altered as suitable. Moreover, it should be understood that the advantages described in association with the embodiments are merely a listing of most preferred advantages, and that the advantages of the present invention are by no means restricted to those described in connected with the embodiments.

What is claimed is:

1. A gaming system, comprising:
a plurality of slot machines transmitting symbol data of a stationary symbol; and
a central controller for establishing communication with each of the plurality of slot machines,
wherein the central controller is configured to perform the following operations of:
(a) receiving a plurality of the symbol data transmitted from each of the plurality of slot machines;
(b) determining whether a combination which is formed by the plurality of symbol data thus received corresponds to a specified combination; and
(c) in a case where a combination which is formed by the plurality of symbol data corresponds to the specified combination, transmitting winning data for providing an award to each of the plurality of slot machines.

2. A gaming system according to claim 1,
further comprising a display device for displaying an image for establishing communication with the central controller, the display device being disposed at a location able to be visually recognized by a player operating each of the plurality of slot machines,
wherein the central controller is configured to further perform the following operation of:
displaying each of symbols corresponding to the symbol data on the display device in response to a reception of symbol data of the stationary symbol from each of the plurality of slot machines.

3. A gaming system according to claim 1,
wherein each of the plurality of slot machines transmits to the central controller data of an amount of credits inserted in the form of coins, and
wherein the central controller comprises memory for storing accumulation coin data, and is configured to further perform the following operations of:
(a) storing in the memory a predetermined ratio in the data of an amount of credits inserted in the form of coins received from the plurality of slot machines as the accumulation coin data; and
(b) in a case where a combination which is formed by the plurality of symbol data corresponds to a specified combination, transmitting the accumulation coin data as winning data.

4. A gaming system according to claim 1,
wherein each of the plurality of slot machines comprises:
a display unit for displaying at least two stationary symbols; and
a local controller configured to perform the following operations of:
(A) transmitting to the central controller symbol data related to a first stationary symbol of the at least two stationary symbols;
(B) in a case where a second stationary symbol of the at least two stationary symbols is a specified symbol for providing an award, providing an award corresponding to the specified symbol; and
(C) in a case of receiving the winning data, providing an award corresponding to the winning data.

5. A gaming system according to claim 1,
wherein each of the plurality of slot machines comprises:
a display unit for displaying at least two stationary symbols; and
a local controller for transmitting first symbol data, which is data for a first stationary symbol, and second symbol data, which is data for a second stationary symbol, of the at least two stationary symbols,
wherein the central controller is configured to further perform the following operations of:
(a) receiving the first symbol data and the second symbol data respectively from each of the plurality of slot machines;
(b) determining whether a combination formed by a plurality of the first symbol data and a combination formed by a plurality of the second symbol data corresponds to a specified combination, respectively; and
(c) in a case where at least any one of a combination formed by a plurality of the first symbol data or a combination formed by a plurality of the second symbol data corresponds to the specified combination, transmitting the winning data to each of the plurality of slot machines.

6. A gaming system according to claim 1,
wherein the central controller is configured to further perform the following operation of:
transmitting combination data, which is data of a combination formed by symbol data received from each of the plurality of slot machines, to each of the plurality of slot machines, and
wherein each of the plurality of slot machines comprises:
a display unit for displaying to a player at least two stationary symbols and a symbol corresponding to combination data transmitted from the central controller; and
a controller configured to perform the following operations of:
(A) transmitting symbol data, which is data for a first stationary symbol of the at least two stationary symbols;
(B) displaying the combination data received from the central controller on the display unit;
(C) in a case where a second stationary symbol of the at least two stationary symbols is a specified symbol for providing an award, providing an award corresponding to the specified symbol; and
(D) in a case of receiving the winning data, providing an award corresponding to the winning data.

7. A gaming system, comprising:
a plurality of slot machines having a display unit for displaying at least two stationary symbols and a local controller for performing processing related to a game;
a display device for displaying an image, the display device being disposed at a location able to be visually recognized by a player operating each of the plurality of slot machines; and
a central controller for establishing communication with each of the plurality of slot machines,
wherein the local controller is configured to perform the following operations of:
(A) transmitting symbol data related to a first stationary symbol of the at least two stationary symbols; and
(B) in a case where symbol data related to a second stationary symbol of the at least two stationary symbols is a specified symbol for providing an award, providing an award corresponding to the specified symbols, and
wherein the central controller is configured to perform the following operations of:
(a) receiving each of the symbol data from the plurality of slot machines;
(b) displaying each of the symbols corresponding to the symbol data on the display device in response to a reception of a plurality of symbol data of the stationary symbols from each of the plurality of slot machines;
(c) determining whether a combination formed by the plurality of symbol data thus received corresponds to a specified combination; and
(d) in a case where a combination formed by the plurality of symbol data corresponds to the specified combination, transmitting winning data for providing an award to each of the plurality of slot machines.

8. A gaming system according to claim 7,
wherein each of the plurality of slot machines transmits data of an amount of credits inserted in the form of coins to the central controller, and
wherein the central controller comprises memory for storing accumulation coin data and is configured to further perform the following operations of:
(a) storing in the memory a predetermined ratio in the data of an amount of credits inserted in the form of coins received from the plurality of slot machines as the accumulation coin data; and
(b) in a case where a combination, which is formed by the plurality of symbol data, corresponds to the specified combination, transmitting the accumulation coin data as the winning data.

9. A gaming system, comprising
a plurality of slot machines having a display unit for displaying at least two stationary symbols and a local controller for performing processing related to a game;
a display device for displaying an image, the display device being disposed at a location able to be visually recognized by a player operating each of the plurality of slot machines; and
a central controller for establishing communication with each of the plurality of slot machines,
wherein the local controller is configured to perform the following operations of:
(A) transmitting first symbol data, which is data for a first stationary symbol, and second symbol data, which is data for second stationary symbol, of the at least two stationary symbols; and
(B) in a case where at least any one of the first stationary symbol and the second stationary symbol corresponds to a specified symbol for providing an award, providing an award, and
wherein the central controller is configured to perform the following operations of:
(a) receiving the first symbol data and the second symbol data, respectively, from each of the plurality of slot machines;
(b) displaying each of symbols corresponding to the first symbol data and the second symbol data on the display device in response to the reception of symbol data of the stationary symbols from each of the plurality of slot machines;
(c) determining whether a combination formed by a plurality of the first symbol data and a combination formed by a plurality of the second symbol data respectively corresponds to a specified combination; and
(d) in a case where any one of a combination formed by a plurality of the symbol data and a combination formed by a plurality of the symbol data corresponds to the specified combination, transmitting winning data for providing an award to each of the plurality of slot machines.

10. A gaming system according to claim 9,
wherein each of the plurality of slot machines transmits data of an amount of credits inserted in the form of coins to the central controller, and
wherein the central controller comprises memory for storing accumulation coin data and is configured to further perform the following operations of:
(a) storing in the memory a predetermined ratio in the data of an amount of credits inserted in the form of coins received from the plurality of slot machines as the accumulation coin data; and
(b) in a case where a combination, which is formed by the plurality of symbol data, corresponds to the specified combination, transmitting the accumulation coin data as the winning data.

11. A gaming system, comprising
a plurality of slot machines having a display unit for displaying at least two stationary symbols and a local controller for performing processing related to a game; and
a central controller for establishing communication with each of the plurality of slot machines,
wherein the central controller is configured to perform the following operations of:
(a) receiving a plurality of symbol data transmitted from each of the plurality of slot machines;
(b) transmitting combination data, which is data for a combination formed by symbol data received from each of the plurality of slot machines, to each of the plurality of slot machines;
(c) determining whether a combination formed by the plurality of symbol data thus received corresponds to a specified combination; and
(d) in a case where a combination formed by the plurality of symbol data corresponds to the specified combination, transmitting winning data for providing an award to each of the plurality of slot machines, and
wherein the local controller is configured to perform the following operations of:
(A) transmitting symbol data, which is data for a first stationary symbol of the at least two stationary symbols, to the central controller;
(B) displaying the combination data received from the central controller on the display unit;
(C) in a case where a second stationary symbol of the at least two stationary symbols corresponds to a specified symbol, providing an award corresponding to the specified symbol; and
(D) in a case of receiving the winning data, providing an award corresponding to the winning data.

12. A gaming system according to claim 11,
wherein each of the plurality of slot machines transmits data of an amount of credits inserted in the form of coins to the central controller,
wherein the central controller comprises memory for storing accumulation coin data and is configured to further perform the following operations of:
(a) storing in the memory a predetermined ratio in the data of an amount of credits inserted in the form of coins received from the plurality of slot machines as the accumulation coin data; and
(b) in a case where a combination which is formed by the plurality of symbol data corresponds to the specified combination, transmitting the accumulation coin data as the winning data.

13. A method of controlling a game of a gaming system having a plurality of slot machines and a central controller for establishing communication with each of the plurality of slot machines, comprising:
(a) the plurality of slot machines transmitting symbol data of a stationary symbol;
(b) the central controller receiving a plurality of the symbol data transmitted from each of the plurality of slot machines;
(c) the central controller determining whether a combination formed by a plurality of the slot machines thus received corresponds to a specified combination; and
(d) in a case where a combination formed by a plurality of the symbol data corresponds to the specified combination, the central controller transmitting winning data for providing an award to each of the plurality of slot machines.

14. A method of controlling a game according to claim 13, the gaming system having a display device for displaying an image so as to establish communication with the central controller, the display device being disposed at a location able to be visually recognized by a player operating each of the plurality of slot machines, comprising:
the central controller displaying each of symbols corresponding to the symbol data on the display device in response to a reception of symbol data of the stationary symbol from each of the plurality of slot machines.

15. A method of controlling a game according to claim 13, comprising:
each of the plurality of slot machines transmitting data of an amount of credits inserted in the form of coins to the central controller;
the central controller, having memory for storing accumulation coin data, storing in the memory a predetermined ratio in the data of an amount of credits inserted in the form of coins received from the plurality of slot machines as the accumulation coin data; and
in a case where a combination, which is formed by the plurality of symbol data, corresponds to a specified combination, the central controller transmitting the accumulation coin data as the winning data.
